(19) United States
(12) Patent Application Publication
(10) Pub. No.: US 2026/0230727 A1
(43) Pub. Date: Aug. 6, 2026

(54) IMAGING ELEMENT, IMAGING DEVICE, CONTROL METHOD OF IMAGING ELEMENT, AND CONTROL PROGRAM OF IMAGING ELEMENT

(71) Applicant: FUJIFILM Corporation, Tokyo (JP)

(72) Inventors: Yoshinori FURUTA, Saitama (JP); Kazuya Oda, Saitama (JP); Tomoyuki Kawai, Saitama (JP); Seiji Tanaka, Saitama (JP)

(73) Assignee: FUJIFILM Corporation, Tokyo (JP)

(21) Appl. No.: 19/577,373

(22) Filed: Mar. 25, 2026

Related U.S. Application Data
(63) Continuation of application No. PCT/JP2024/014994, filed on Apr. 15, 2024.

(30) Foreign Application Priority Data
Sep. 29, 2023 (JP) 2023-169880

(51) Int. Cl. H04N 25/704; H04N 25/13

(52) U.S. Cl. CPC H04N 25/704; H04N 25/134

(57) ABSTRACT

An imaging element includes: a plural pixels, the plural pixels include first pixels for phase difference detection and second pixels different from the first pixels, the second pixels include plural types of pixels corresponding to plural wavelength bands, and the first pixels include a first-type pixel corresponding to at least one of the plural wavelength bands and a second-type pixel different from the first-type pixel and corresponding to two or more of the plural wavelength bands,

### CROSS REFERENCE TO RELATED APPLICATION

This is a continuation of International Application No. PCT/JP2024/014994 filed on April 15, 2024, and claims priority from Japanese Patent Application No. 2023-169880 filed on September 29, 2023, the entire disclosures of which are incorporated herein by reference.

### BACKGROUND OF THE INVENTION

### 1. Field of the Invention

The technology of the present disclosure relates to an imaging element, an imaging device, a control method of an imaging element, and a computer readable medium storing a control program of an imaging element.

### 2. Description of the Related Art

WO2013/031537A describes an imaging element having a configuration in which a color filter is not provided in a phase difference pixel.

JP2016-57546A describes an imaging element having a configuration in which a transparent filter is provided in a phase difference pixel.

JP2012-134581A describes an imaging element comprising a phase difference pixel and an image generation pixel. The image generation pixel in the imaging element is composed of a red pixel, a blue pixel, and a green pixel, and the phase difference pixel is covered by a white filter or a transparent layer that transmits light in a visible light region.

JP2022-103180A describes an imaging element having a configuration in which a color filter is not provided in a phase difference pixel.

### SUMMARY OF THE INVENTION

An imaging element, an imaging device, a control method of an imaging element, and a computer readable medium storing a control program of an imaging element according to one embodiment of the technology of the present disclosure are as follows. Components and the like corresponding to those in the embodiment described later are described in parentheses, but the present disclosure is not limited thereto.

### (1)

An imaging element (imaging element 5) comprising: a plurality of pixels (pixels 61), in which the plurality of pixels include a first pixel (phase difference pixel P1) for phase difference detection and a second pixel (normal pixel P2) different from the first pixel, the second pixel includes a plurality of types of pixels (normal pixel 61R, normal pixel 61G, and normal pixel 61B) corresponding to a plurality of wavelength bands, and the first pixel includes a first-type pixel (phase difference pixel 61FAg and phase difference pixel 61FBg or phase difference pixel 61FAc and phase difference pixel 61FBc) corresponding to at least one of the plurality of wavelength bands and a second-type pixel (phase difference pixel 61FAw and phase difference pixel 61FBw or phase difference pixel 61FAy and phase difference pixel 61FBy) different from the first-type pixel and corresponding to two or more of the plurality of wavelength bands.

### (2)

The imaging element according to (1), in which the first-type pixel corresponds to any of the plurality of wavelength bands, and the second-type pixel corresponds to the plurality of wavelength bands.

### (3)

The imaging element according to (2), in which the plurality of wavelength bands include a first wavelength band, a second wavelength band, and a third wavelength band.

### (4)

The imaging element according to (3), in which the first wavelength band is a red wavelength band, the second wavelength band is a green wavelength band, the third wavelength band is a blue wavelength band, and the first-type pixel corresponds to the second wavelength band.

### (5)

The imaging element according to (1), in which the first-type pixel corresponds to two or more of the plurality of wavelength bands.

### (6)

The imaging element according to (5), in which the plurality of wavelength bands include a first wavelength band, a second wavelength band, and a third wavelength band, the first-type pixel corresponds to the second wavelength band and the third wavelength band, and the second-type pixel corresponds to the first wavelength band and the second wavelength band.

### (7)

The imaging element according to (6), in which the second pixels are arranged in a predetermined pattern, and the first-type pixels (phase difference pixel 61FAc and phase difference pixel 61FBc) are provided at a portion of arrangement positions of the second pixels (normal pixels 61G) corresponding to the second wavelength band based on the pattern and a portion of arrangement positions of the second pixels (normal pixels 61B) corresponding to the third wavelength band based on the pattern.

### (8)

The imaging element according to (7), in which the second-type pixels (phase difference pixel 61FAy and phase difference pixel 61FBy) are provided at a portion of arrangement positions of the second pixels (normal pixels 61R) corresponding to the first wavelength band based on the pattern and a portion of arrangement positions of the second pixels (normal pixels 61G) corresponding to the second wavelength band based on the pattern.

### (9)

The imaging element according to any one of (1) to (8), further comprising: an imaging surface (imaging surface 60) in which a plurality of pixel groups each including a plurality of the pixels arranged in a first direction are arranged in a second direction intersecting the first direction, in which the first-type pixel and the second-type pixel are included in different pixel groups.

### (10)

The imaging element according to (9), in which the first pixel is capable of detecting a phase difference in the first direction.

### (11)

The imaging element according to any one of (2) to (4), in which the second pixels are arranged in a predetermined pattern, the first pixels are provided at a portion of arrangement positions of the second pixels based on the pattern, and a filter (color filter CFa and color filter CFb) that transmits a corresponding wavelength band of the second pixel corresponding to the arrangement position of the second-type pixel based on the pattern is provided at a peripheral edge portion of the second-type pixel (phase difference pixel 61FAw and phase difference pixel 61FBw).

### (12)

The imaging element according to (11), further comprising: an imaging surface (imaging surface 60) in which a plurality of pixel groups each including a plurality of the pixels arranged in a first direction are arranged in a second direction intersecting the first direction, in which a width of the filter in the first direction at an end portion of the second-type pixel in the first direction and a width of the filter in the second direction at an end portion of the second-type pixel in the second direction are different depending on a position of the second-type pixel on the imaging surface.

### (13)

The imaging element according to any one of (5) to (9), in which the second pixels are arranged in a predetermined pattern, the first pixel is provided at a portion of arrangement positions of the second pixels based on the pattern, and a filter (color filter CFa and color filter CFb) that transmits a corresponding wavelength band of the second pixel corresponding to the arrangement position of the first pixel based on the pattern is provided at a peripheral edge portion of the first pixel (phase difference pixel 61FAc, phase difference pixel 61FBc, phase difference pixel 61FAy, and phase difference pixel 61FBy).

### (14)

The imaging element according to (13), further comprising: an imaging surface in which a plurality of pixel groups each including a plurality of the pixels arranged in a first direction are arranged in a second direction intersecting the first direction, in which a width of the filter in the first direction at an end portion of the first pixel in the first direction and a width of the filter in the second direction at an end portion of the first pixel in the second direction are different depending on a position of the first pixel on the imaging surface.

### (15)

The imaging element according to any one of (1) to (14), in which the plurality of wavelength bands are within a wavelength band of visible light.

### (16)

An imaging device comprising: the imaging element according to any one of (1) to (15); and a processor (system control unit 11) that performs a focus detection process based on a pixel value of the first pixel.

### (17)

The imaging device according to (16), in which the processor performs control of making exposure times different between the first-type pixel and the second-type pixel.

### (18)

A control method of an imaging element including a plurality of pixels, in which the plurality of pixels include a first pixel for phase difference detection and a second pixel different from the first pixel, the second pixel includes a plurality of types of pixels corresponding to a plurality of wavelength bands, and the first pixel includes a first-type pixel corresponding to at least one of the plurality of wavelength bands and a second-type pixel different from the first-type pixel and corresponding to two or more of the plurality of wavelength bands, the control method comprising: a step of performing control of making exposure times different between the first-type pixel and the second-type pixel.

### (19)

A computer readable medium storing a control program of an imaging element including a plurality of pixels, in which the plurality of pixels include a first pixel for phase difference detection and a second pixel different from the first pixel, the second pixel includes a plurality of types of pixels corresponding to a plurality of wavelength bands, and the first pixel includes a first-type pixel corresponding to at least one of the plurality of wavelength bands and a second-type pixel different from the first-type pixel and corresponding to two or more of the plurality of wavelength bands, the control program causing a processor to execute: a step of performing control of making exposure times different between the first-type pixel and the second-type pixel.

### BRIEF DESCRIPTION OF THE DRAWINGS

FIG. 1 is a diagram illustrating a schematic configuration of a digital camera 100 that is an embodiment of an imaging device according to the technology of the present disclosure.

FIG. 2 is a schematic plan view illustrating a schematic configuration of an imaging element 5 illustrated in FIG. 1.

FIG. 3 is a schematic diagram illustrating an imaging surface 60 of the imaging element 5 illustrated in FIG. 2 in a partially enlarged manner.

FIG. 4 is a schematic diagram illustrating an example of a cross section of a range A1 illustrated in FIG. 3.

FIG. 5 is a schematic diagram illustrating an example of a cross section of a range A2 illustrated in FIG. 3.

FIG. 6 is a schematic diagram illustrating an example of a cross section of a range A3 illustrated in FIG. 3.

FIG. 7 is a schematic diagram illustrating a modification example of a cross-sectional structure of a phase difference detection pair.

FIG. 8 is a schematic diagram illustrating a first modification example of the imaging element 5, and is a diagram corresponding to FIG. 3.

FIG. 9 is a diagram illustrating a second modification example of the imaging element 5, and is a diagram corresponding to FIG. 3.

FIG. 10 is a diagram illustrating a third modification example of the imaging element 5, and is a diagram corresponding to FIG. 3.

FIG. 11 is a schematic diagram illustrating an example of a cross section of a range A4 illustrated in FIG. 10.

FIG. 12 is a schematic diagram illustrating an example of a cross section of a range A5 illustrated in FIG. 10.

FIG. 13 is a schematic diagram illustrating a fourth modification example of the imaging element 5.

FIG. 14 is a diagram illustrating a preferred example of color filters CFa and CFb illustrated in FIG. 13.

FIG. 15 is a diagram illustrating a preferred example of the color filters CFa and CFb illustrated in FIG. 13.

FIG. 16 is a diagram illustrating a preferred example of the color filters CFa and CFb illustrated in FIG. 13.

FIG. 17 is a diagram illustrating a preferred example of the color filters CFa and CFb illustrated in FIG. 13.

FIG. 18 is a diagram illustrating a configuration example of a color filter mounted on a phase difference pixel 61FAy and a phase difference pixel 61FBy of the imaging element 5 illustrated in FIG. 10.

FIG. 19 is a diagram illustrating a configuration example of a color filter mounted on a phase difference pixel 61FAc and a phase difference pixel 61FBc of the imaging element 5 illustrated in FIG. 10.

FIG. 20 is a diagram illustrating an appearance of a smartphone 200.

FIG. 21 is a block diagram illustrating a configuration of the smartphone 200 illustrated in FIG. 20.

### DESCRIPTION OF THE PREFERRED EMBODIMENTS

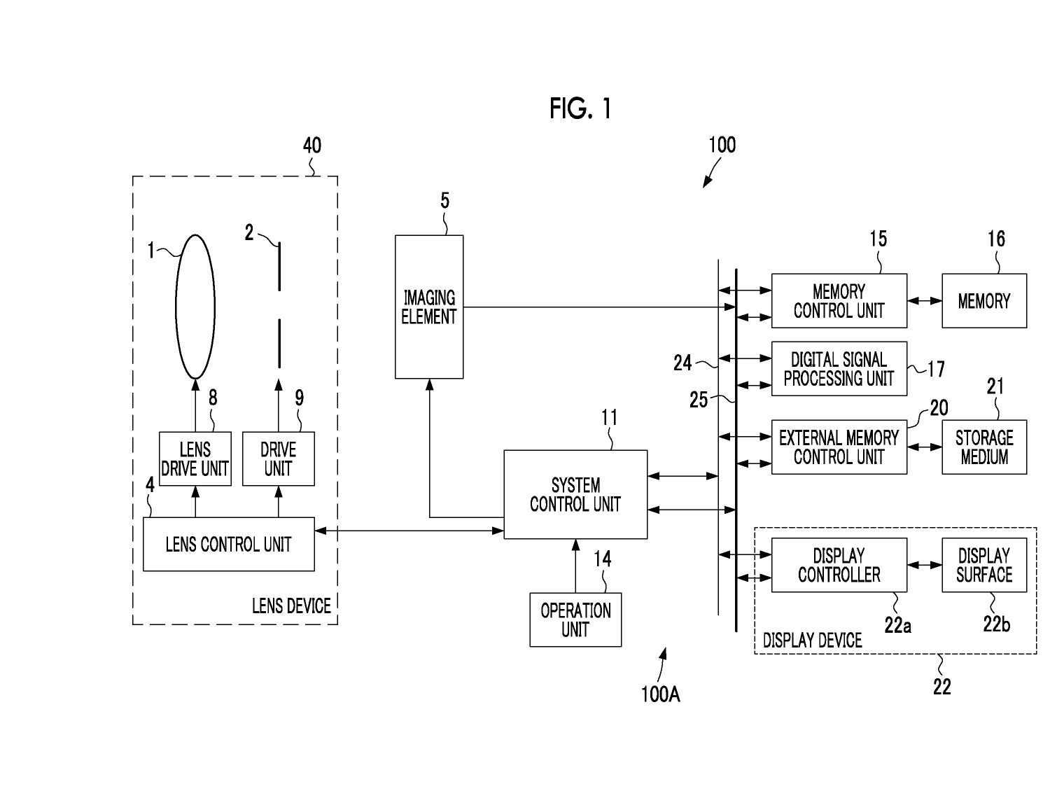

FIG. 1 is a diagram illustrating a schematic configuration of a digital camera 100 that is an embodiment of an imaging device according to the technology of the present disclosure. The digital camera 100 illustrated in FIG. 1 comprises a lens device 40 including an imaging lens 1, a stop 2, a lens drive unit 8 that drives the imaging lens 1, a stop drive unit 9 that drives the stop 2, and a lens control unit 4 that controls the lens drive unit 8 and the stop drive unit 9, and a body part 100A.

The body part 100A comprises an imaging element 5, a system control unit 11 that manages and controls the entire electric control system of the digital camera 100, an operation unit 14, a display device 22, a memory 16 including a random-access memory (RAM), a read-only memory (ROM), and the like, and a memory control unit 15 that controls data storage in the memory 16 and data readout from the memory 16, a digital signal processing unit 17, and an external memory control unit 20 that controls data storage in a storage medium 21 and data readout from the storage medium 21.

The lens device 40 may be attachable to and detachable from the body part 100A or integrated with the body part 100A. The imaging lens 1 includes a focus lens.

The focus lens is a lens for adjusting the focus of an imaging optical system including the imaging lens 1 and the stop 2, and is composed of a single lens or of a plurality of lenses. By moving the focus lens in the optical axis direction, a position of a principal point of the focus lens (hereinafter, also referred to as a focus lens position) changes along the optical axis direction, and the focus on a subject side is changed. In addition, a liquid lens of which a position of a principal point in the optical axis direction can be changed by electrical control may be used as the focus lens.

The lens control unit 4 of the lens device 40 controls the lens drive unit 8 based on a lens drive signal transmitted from the system control unit 11 to change the focus lens position. The lens control unit 4 of the lens device 40 changes an aperture amount of the stop 2 by controlling the stop drive unit 9 based on a driving control signal transmitted from the system control unit 11.

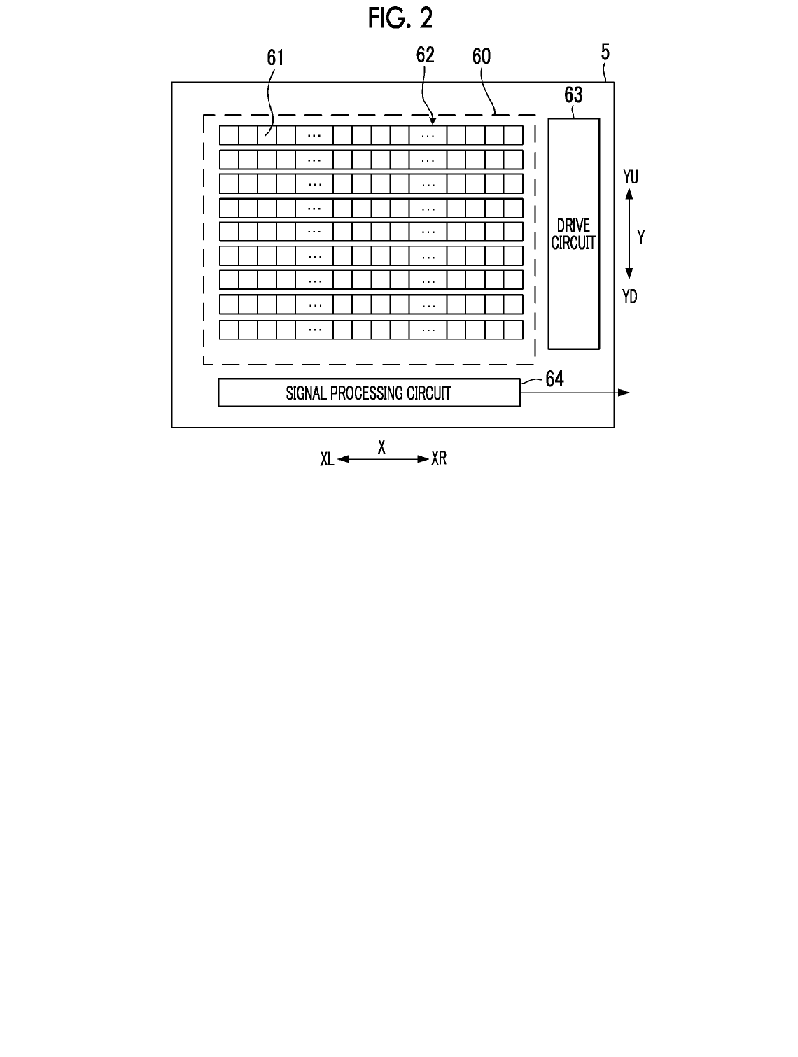

The imaging element 5 images the subject through the imaging optical system provided between the imaging element 5 and the subject. The imaging element 5 includes an imaging surface 60 (see FIG. 2) on which a plurality of pixels are two-dimensionally arranged, converts a subject image formed on the imaging surface 60 by the imaging optical system into image signals by the plurality of pixels, and outputs the image signals. The output from the pixel included in the imaging element 5 is referred to as a pixel signal or a pixel value, and the set of the pixel signals or the pixel values is referred to as an image signal.

For example, a complementary metal-oxide-semiconductor (CMOS) image sensor or a charge coupled device (CCD) image sensor is used as the imaging element 5. Hereinafter, an example will be described in which the imaging element 5 is a CMOS image sensor.

The system control unit 11 controls the entire digital camera 100 in an integrated manner, and the hardware structure includes various processors that execute the program to perform processing. A program (including a control program of the imaging element 5) executed by the system control unit 11 is stored in a read-only memory (ROM) (non-transitory storage medium) of the memory 16. The memory 16 and the system control unit 11 constitute a control device for the imaging element 5.

Examples of the various processors include a central processing unit (CPU) that is a general-purpose processor performing various types of processing by executing a program, a programmable logic device (PLD) such as a field programmable gate array (FPGA) that is a processor whose circuit configuration can be changed after manufacture, or a dedicated electric circuit such as an application specific integrated circuit (ASIC) that is a processor having a circuit configuration dedicatedly designed to execute specific processing. More specifically, the structure of these various processors is an electric circuit in which circuit elements, such as semiconductor elements, are combined.

The system control unit 11 may be configured by one of the various processors, or may be configured by a combination of two or more processors of the same type or different types (for example, a combination of a plurality of the FPGAs or a combination of the CPU and the FPGA).

The system control unit 11 drives the imaging element 5 and the lens device 40 and outputs the subject image captured through the imaging optical system of the lens device 40 as the image signal. By processing the image signal output from the imaging element 5 via the digital signal processing unit 17, captured image data that is data suitable for display on the display device 22 or is data suitable for storage in the storage medium 21 is generated.

A command signal from a user is input to the system control unit 11 through the operation unit 14. The operation unit 14 includes a touch panel integrated with a display surface 22b, various buttons, and the like.

The display device 22 comprises the display surface 22b configured by an organic electroluminescence (EL) panel, a liquid crystal panel, or the like, and a display controller 22a that controls display on the display surface 22b.

The memory control unit 15, the digital signal processing unit 17, the external memory control unit 20, and the display controller 22a are connected to each other through a control bus 24 and through a data bus 25 and are controlled according to commands from the system control unit 11.

FIG. 2 is a schematic plan view illustrating a schematic configuration of the imaging element 5 illustrated in FIG. 1. The imaging element 5 comprises an imaging surface 60 in which a plurality of pixel groups 62 each including a plurality of pixels 61 arranged in a row direction X are arranged in a column direction Y intersecting the row direction X, a drive circuit 63 that drives the pixels 61 arranged on the imaging surface 60, and a signal processing circuit 64 that processes the pixel signal read from each pixel 61 of the pixel group 62 arranged on the imaging surface 60 into a signal line.

In the example of FIG. 2, the row direction X and the column direction Y are orthogonal to each other. One side of the row direction X is referred to as a right direction XR, and the other side of the row direction X is referred to as a left direction XL. One side of the column direction Y is referred to as an up direction YU, and the other side of the column direction Y is referred to as a down direction YD.

It can also be said that a plurality of pixel groups each including the plurality of pixels 61 arranged in the column direction Y are disposed in the row direction X on the imaging surface 60. One of the row direction X or the column direction Y constitutes a first direction, and the other of the row direction X or the column direction Y constitutes a second direction.

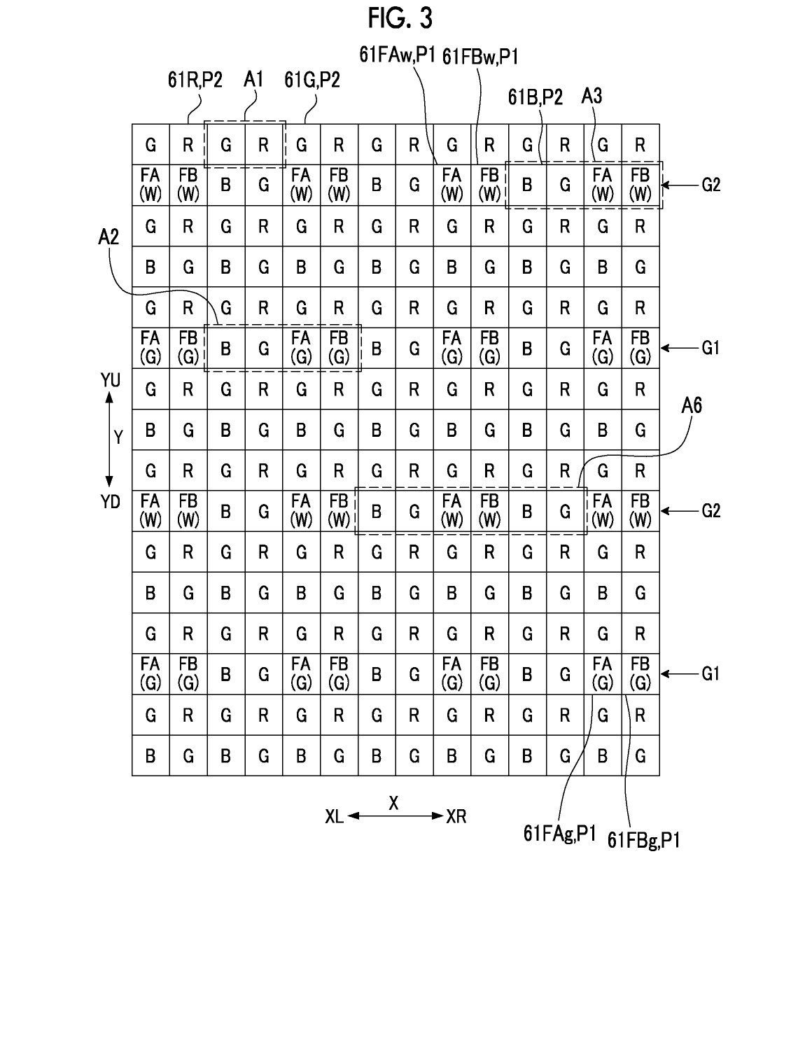

FIG. 3 is a schematic diagram illustrating a partially enlarged imaging surface 60 of the imaging element 5 illustrated in FIG. 2. The plurality of pixels 61 disposed on the imaging surface 60 include a phase difference pixel P1 (block to which characters "FA" or "FB" are added in the drawing) for phase difference detection and a normal pixel P2 different from the phase difference pixel P1. The normal pixel P2 has optical characteristics (change in output with respect to an incidence angle of light) different from those of the phase difference pixel P1. The phase difference pixel P1 constitutes a first pixel, and the normal pixel P2 constitutes a second pixel.

The normal pixel P2 includes a plurality of types of pixels corresponding to a plurality of wavelength bands. The plurality of wavelength bands are within a wavelength band of visible light (for example, a wavelength band of 350 nm or more and 800 nm or less).

The plurality of wavelength bands include, for example, a red wavelength band (for example, a wavelength band of 600 nm or more and 800 nm or less, hereinafter also referred to as R light), a green wavelength band (for example, a wavelength band of 500 nm or more and less than 600 nm, hereinafter also referred to as G light), and a blue wavelength band (for example, a wavelength band of 400 nm or more and less than 500 nm, hereinafter also referred to as B light). The R light constitutes a first wavelength band, the G light constitutes a second wavelength band, and the B light constitutes a third wavelength band.

In the example of FIG. 3, the plurality of pixels 61 include, as the normal pixel P2, a normal pixel 61R (a block to which a character "R" is added in the drawing) corresponding to the R light, a normal pixel 61G (a block to which a character "G" is added in the drawing) corresponding to the G light, and a normal pixel 61B (a block to which a character "B" is added in the drawing) corresponding to the B light. The normal pixel 61R, the normal pixel 61G, and the normal pixel 61B receive at least a portion of the corresponding wavelength band and output a pixel signal corresponding to the amount of the received light.

The phase difference pixels P1 include a first-type pixel corresponding to G light among the plurality of wavelength bands (R light, G light, and B light) (the phase difference pixels 61FAg and 61FBg labeled with the characters "FA(G)" in the drawing), and a second-type pixel that is different from the first-type pixel and corresponds to the plurality of wavelength bands (R light, G light, and B light) (the phase difference pixels 61FAw and 61FBw labeled with the characters "FA(W)" in the drawing).

The first-type pixel and the second-type pixel have different spectral characteristics.

The phase difference pixel 61FAg and the phase difference pixel 61FBg receive at least a portion of the corresponding G light and output a pixel signal corresponding to the amount of the received light.

The phase difference pixel 61FAw and the phase difference pixel 61FBw receive at least a portion of each of the plurality of wavelength bands (R light, G light, and B light) and output a pixel signal corresponding to the amount of the received light. That is, the phase difference pixel 61FAw and the phase difference pixel 61FBw receive at least a portion of the R light, at least a portion of the G light, and at least a portion of the B light, and output a pixel signal corresponding to the amount of the received light. Since the phase difference pixel 61FAw and the phase difference pixel 61FBw can receive light of more wavelengths than the phase difference pixel 61FAg and the phase difference pixel 61FBg, the sensitivity can be increased.

On the imaging surface 60, the normal pixel 61R, the normal pixel 61G, and the normal pixel 61B are arranged based on a predetermined pattern (a Bayer pattern in the illustrated example). That is, a GR pixel group in which the normal pixel 61G and the normal pixel 61R are alternately arranged in the row direction X and a BG pixel group in which the normal pixel 61B and the normal pixel 61G are alternately arranged in the row direction X are alternately arranged in the column direction Y on the imaging surface 60. The arrangement pattern of the pixels 61 disposed on the imaging surface 60 is not limited to the Bayer pattern, and various patterns can be adopted.

The phase difference pixel P1 is provided at a portion of an arrangement position of the normal pixel P2 based on the Bayer pattern.

Specifically, in a portion of the BG pixel group in the plurality of pixel groups provided on the imaging surface 60, the phase difference pixel 61FAg is disposed at a portion of an arrangement position of the normal pixel 61B based on the Bayer pattern, and the phase difference pixel 61FBg is disposed at a portion of an arrangement position of the normal pixel 61G based on the Bayer pattern. The phase difference pixel 61FAg and the phase difference pixel 61FBg are adjacent to each other. A plurality of first-type phase difference detection pairs each consisting of the phase difference pixel 61FAg and the adjacent phase difference pixel 61FBg are arranged in the row direction X with a gap in the portion of the BG pixel group. The portion of the BG pixel group may be composed of only the first-type phase difference detection pair. A plurality of pixel groups G1 each including the first-type phase difference detection pair are arranged in the column direction Y on the imaging surface 60 in a discrete manner.

In addition, in a portion of the BG pixel group that does not include the first-type phase difference detection pair in the plurality of pixel groups provided on the imaging surface 60, the phase difference pixel 61FAw is disposed at a portion of an arrangement position of the normal pixel 61B based on the Bayer pattern, and the phase difference pixel 61FBw is disposed at a portion of an arrangement position of the normal pixel 61G based on the Bayer pattern. The phase difference pixel 61FAw and the phase difference pixel 61FBw are adjacent to each other. A plurality of second-type phase difference detection pairs each consisting of the phase difference pixel 61FAw and the adjacent phase difference pixel 61FBw are arranged in the row direction X with a gap in the portion of the BG pixel group. The portion of the BG pixel group may be composed of only the second-type phase difference detection pair. A plurality of pixel groups G2 each including the second-type phase difference detection pair are arranged in the column direction Y on the imaging surface 60 in a discrete manner. As illustrated in FIG. 3, the pixel group G1 and the pixel group G2 are alternately arranged in the column direction Y.

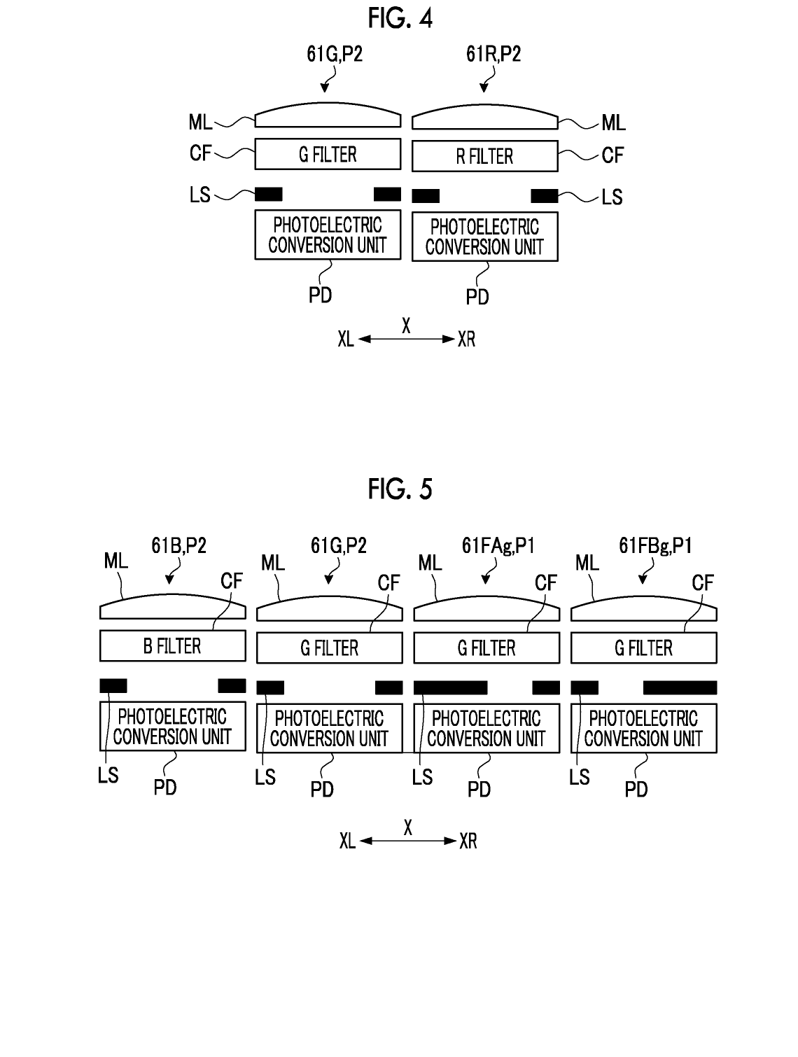

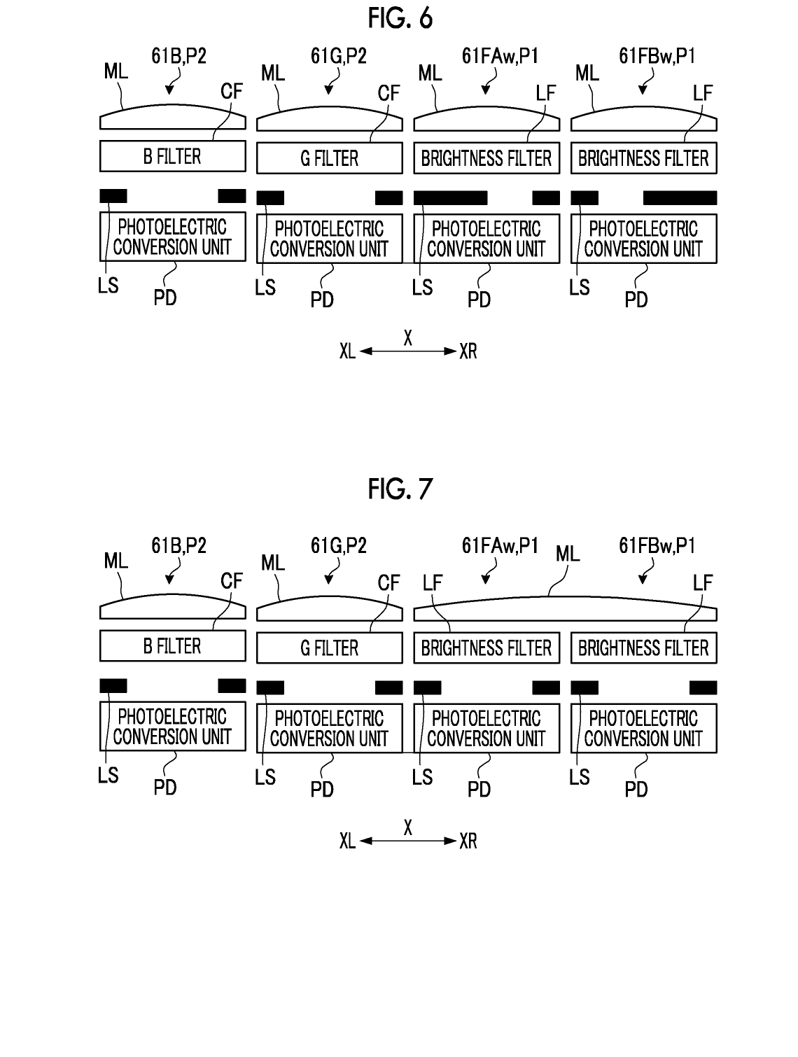

FIG. 4 is a schematic diagram illustrating an example of a cross section of a range A1 illustrated in FIG. 3. FIG. 5 is a schematic diagram illustrating an example of a cross section of a range A2 illustrated in FIG. 3. FIG. 6 is a schematic diagram illustrating an example of a cross section of a range A3 illustrated in FIG. 3.

As illustrated in FIGS. 4 to 6, the normal pixel P2 provided on the imaging surface 60 includes a microlens ML that collects light from the subject, a photoelectric conversion unit PD that converts the light collected by the microlens ML into electric charge, a color filter CF that transmits light in a specific wavelength band provided between the photoelectric conversion unit PD and the microlens ML, and a light shielding film LS provided between the color filter CF and the photoelectric conversion unit PD. The photoelectric conversion unit PD is a photodiode formed in a semiconductor substrate such as silicon, but the photoelectric conversion unit PD may be composed of an organic material film or the like disposed above the semiconductor substrate.

The color filter CF (referred to as an R filter in FIG. 4) included in the normal pixel 61R transmits at least a portion of the R light, the color filter CF (referred to as a G filter in FIGS. 4 to 6) included in the normal pixel 61G transmits at least a portion of the G light, and the color filter CF (referred to as a B filter in FIGS. 5 and 6) included in the normal pixel 61B transmits at least a portion of the B light.

As illustrated in FIG. 5, the phase difference pixel 61FAg and the phase difference pixel 61FBg have a configuration in which the size of an opening of the light shielding film LS is changed with respect to the configuration of the normal pixel 61G. The opening of the light shielding film LS of the phase difference pixel 61FAg has, for example, a configuration in which a left half of the opening of the light shielding film LS of the normal pixel 61G is closed. The opening of the light shielding film LS of the phase difference pixel 61FBg has, for example, a configuration in which a right half of the opening of the light shielding film LS of the normal pixel 61G is closed.

As illustrated in FIG. 6, the phase difference pixel 61FAw and the phase difference pixel 61FBw have configurations in which the size of the opening of the light shielding film LS is changed and the color filter CF is changed to a brightness filter LF with respect to the configuration of the normal pixel P2.

The brightness filter LF has spectral characteristics correlated with a brightness component of light, and examples of the brightness filter LF include a neutral density (ND) filter, a transparent filter, a white filter, and a gray filter. In a configuration in which no member that hinders transmission of light is provided between the microlens ML and the light shielding film LS and light directly enters the photoelectric conversion unit PD, it can also be said that the brightness filter LF is provided. The brightness filter LF can transmit light with a large number of wavelength components as compared with the color filter CF. The brightness filter LF transmits at least a portion of the R light, at least a portion of the G light, and at least a portion of the B light.

The opening of the light shielding film LS of the phase difference pixel 61FAw has, for example, a configuration in which a left half of the opening of the light shielding film LS of the normal pixel P2 is closed. The opening of the light shielding film LS of the phase difference pixel 61FBw has, for example, a configuration in which a right half of the opening of the light shielding film LS of the normal pixel P2 is closed.

With such a configuration of the light shielding film LS, the phase difference pixel 61FAg and the phase difference pixel 61FAw receive one of a pair of luminous fluxes that have passed through two different portions arranged in the row direction X of the pupil region of the imaging optical system of the lens device 40. In addition, the phase difference pixel 61FBg and the phase difference pixel 61FBw receive the other of the pair of luminous fluxes. In addition, the normal pixel P2 receives both of the pair of luminous fluxes.

In the examples of FIGS. 4 to 6, the optical characteristics of the phase difference pixel P1 and the normal pixel P2 are changed by the shape of the light shielding film LS, but the optical characteristics can also be realized by the shape of the microlens ML.

For example, as illustrated in FIG. 7, the opening size of the light shielding film LS of all the pixels 61 may be the same, and, instead of this, in the second-type phase difference detection pair, the microlens ML may be common to the phase difference pixel 61FAw and the phase difference pixel 61FBw. Although not illustrated, in the first-type phase difference detection pair, the microlens ML may be common to the phase difference pixel 61FAg and the phase difference pixel 61FBg.

The system control unit 11 performs a focus detection process based on the pixel value of the phase difference pixel P1. Specifically, the system control unit 11 detects a first phase difference in the row direction X by performing correlation calculation between a pixel signal group output from the phase difference pixel 61FAg included in the same pixel group G1 and a pixel signal group output from the phase difference pixel 61FBg. In addition, the system control unit 11 detects a second phase difference in the row direction X by performing correlation calculation between a pixel signal group output from the phase difference pixel 61FAw included in the same pixel group G2 and a pixel signal group output from the phase difference pixel 61FBw. The system control unit 11 performs a focus detection process of deriving the focus lens position required for focusing on the target subject based on at least one of the first phase difference or the second phase difference.

The second-type phase difference detection pair can receive light having a larger number of wavelength bands than the first-type phase difference detection pair, and the sensitivity can be increased. Therefore, the detection accuracy of the second phase difference derived based on the pixel value of the second-type phase difference detection pair can be increased. On the other hand, since the second-type phase difference detection pair can receive light having a plurality of wavelength bands, there is a subject that is not good at detecting the phase difference.

For example, in a case where the subject includes an RB stripe pattern in which a red subject region extending linearly in the column direction Y and a blue subject region extending linearly in the column direction Y are alternately arranged in the row direction X, a BG stripe pattern in which a blue subject region extending linearly in the column direction Y and a green subject region extending linearly in the column direction Y are alternately arranged in the row direction X, and an RG stripe pattern in which a red subject region extending linearly in the column direction Y and a green subject region extending linearly in the column direction Y are alternately arranged in the row direction X, it may be difficult to detect the second phase difference.

However, in a case of the subject including the BG stripe pattern or the RG stripe pattern, the first phase difference can be detected with high accuracy by using the pixel value of the first-type phase difference detection pair. For example, in a case where the second phase difference cannot be detected or the second phase difference can be detected but the reliability is equal to or less than a threshold value, the system control unit 11 determines the focus lens position based on the first phase difference. In this manner, the detection accuracy of the phase difference is increased, and the focusing control can be performed with high accuracy.

The system control unit 11 may perform control of making the exposure times different between the pixel group G1 including the first-type phase difference detection pair and the pixel group G2 including the second-type phase difference detection pair. For example, the system control unit 11 controls the exposure time of the pixel group G1 to a first time, and controls the exposure time of the pixel group G2 to a second time shorter than the first time.

Since the sensitivity of the second-type phase difference detection pair included in the pixel group G2 is high, the saturation of the pixel value can be prevented by shortening the exposure time. On the other hand, the exposure time of the first-type phase difference detection pair included in the pixel group G1 is lengthened to improve the signal-to-noise ratio. These effects can further improve the detection accuracy of the phase difference.

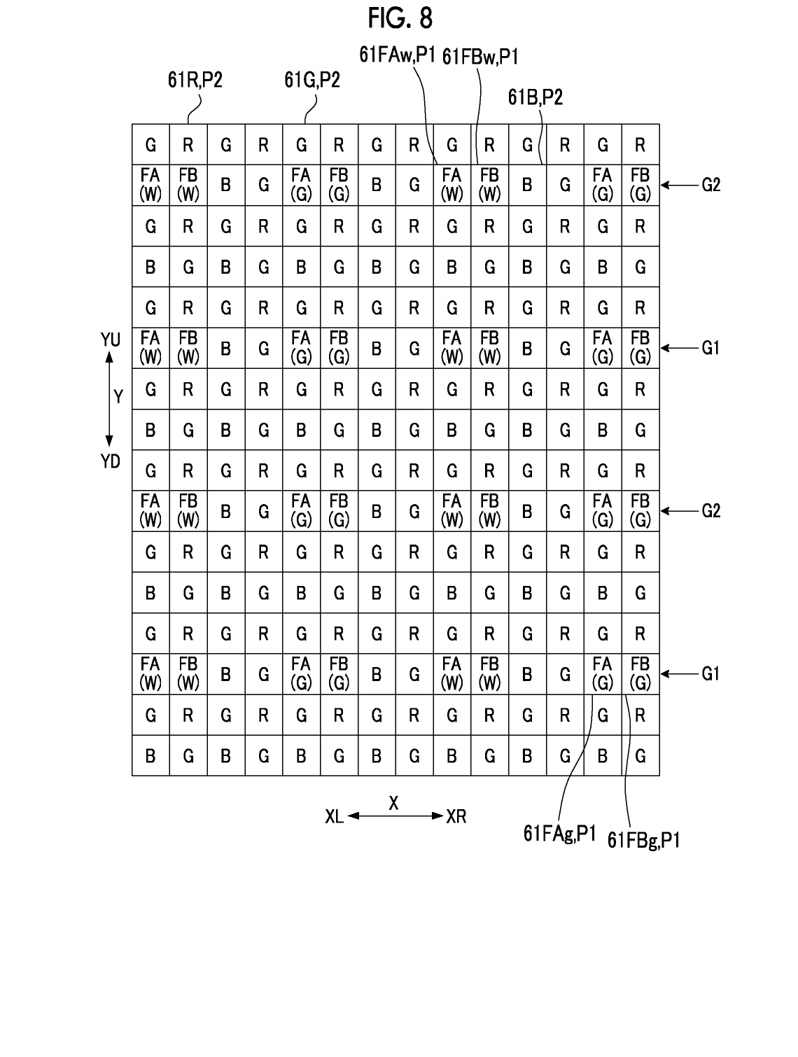

FIG. 8 is a schematic diagram illustrating a first modification example of the imaging element 5, and is a diagram corresponding to FIG. 3. The imaging element 5 of the modification example illustrated in FIG. 8 has a configuration in which a portion of the first-type phase difference detection pairs disposed in the pixel group G1 is changed to the second-type phase difference detection pair and a portion of the second-type phase difference detection pairs disposed in the pixel group G2 is changed to the first-type phase difference detection pair with respect to the imaging element 5 illustrated in FIG. 3. In the example of FIG. 8, in each of the pixel group G1 and the pixel group G2, the first-type phase difference detection pair and the second-type phase difference detection pair are alternately arranged and disposed in the row direction X.

Even in the configuration illustrated in FIG. 8, the detection accuracy of the phase difference can be increased. In a case of the configuration illustrated in FIG. 8, the system control unit 11 can detect the phase difference based on the pixel value of the first-type phase difference detection pair included in the pixel group G1 and can detect the phase difference based on the pixel value of the second-type phase difference detection pair included in the pixel group G1.

In the configuration illustrated in FIG. 3, the arrangement interval of the first-type phase difference detection pair in the row direction X and the arrangement interval of the second-type phase difference detection pair in the row direction X can be narrowed as compared with the configuration illustrated in FIG. 8. Therefore, with the configuration illustrated in FIG. 3, the detection accuracy of the phase difference can be further improved. In addition, with the configuration illustrated in FIG. 3, since the first-type phase difference detection pair and the second-type phase difference detection pair are included in different pixel groups, the control is facilitated even in a case where the exposure times are changed between the first-type phase difference detection pair and the second-type phase difference detection pair, and the manufacturing cost of the digital camera 100 can be reduced.

In the examples of FIGS. 3 and 8, the two pixels 61 constituting the first-type phase difference detection pair correspond to the G light, but the present disclosure is not limited to this. For example, the two pixels 61 constituting the first-type phase difference detection pair may correspond to the R light or correspond to the B light.

As the first-type phase difference detection pair, a configuration may be adopted in which two or more of the pixels corresponding to the R light, the G light, and the B light are included on the imaging surface 60.

In the above description, the phase difference detection pair for detecting the phase difference in the row direction X is disposed on the imaging surface 60. The technology of the present disclosure can be similarly applied to the imaging element 5 in which the phase difference detection pair for detecting the phase difference in the column direction Y is disposed on the imaging surface 60. In addition, the technology of the present disclosure can be similarly applied to the imaging element 5 in which the phase difference detection pair for detecting the phase difference in the row direction X and the phase difference detection pair for detecting the phase difference in the column direction Y are disposed on the imaging surface 60.

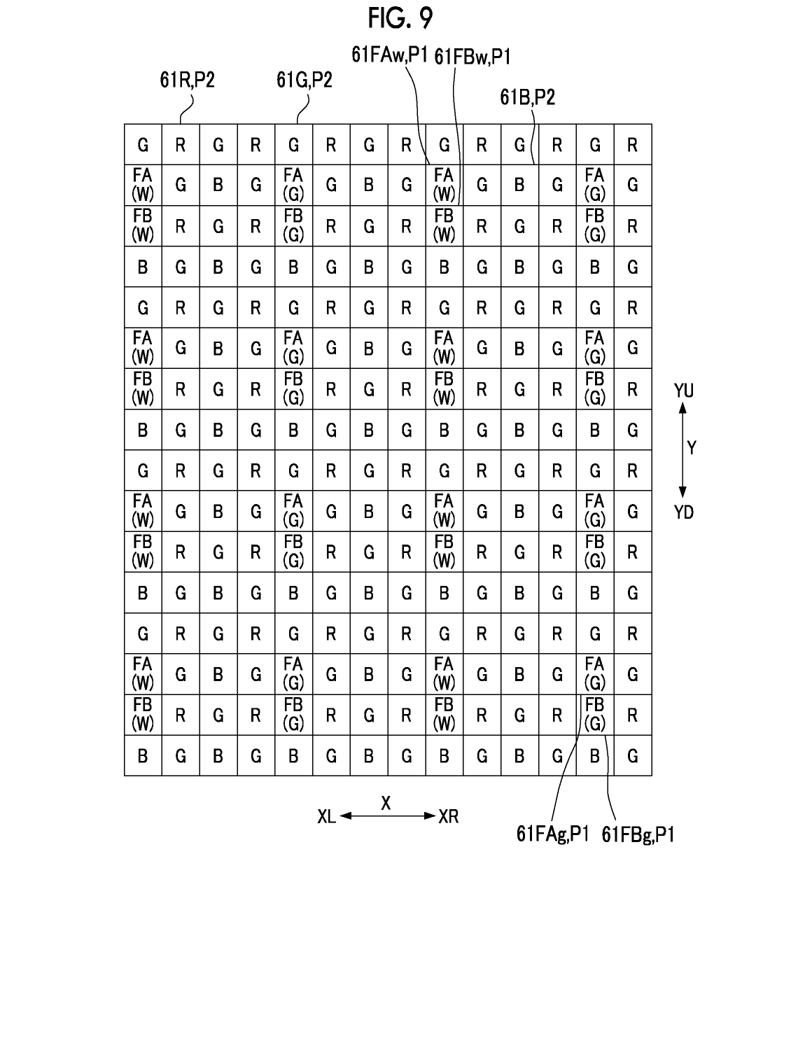

FIG. 9 is a diagram illustrating a second modification example of the imaging element 5, and is a diagram corresponding to FIG. 3. The imaging element 5 illustrated in FIG. 9 has a configuration in which, in the imaging element 5 illustrated in FIG. 8, the position of the phase difference pixel 61FBg constituting the first-type phase difference detection pair is changed to be adjacent to the phase difference pixel 61FAg constituting the first-type phase difference detection pair in the down direction YD, and the normal pixel 61G is disposed at a position at which the original phase difference pixel 61FBg is disposed.

In addition, the imaging element 5 illustrated in FIG. 9 has a configuration in which, in the imaging element 5 illustrated in FIG. 8, the position of the phase difference pixel 61FBw constituting the second-type phase difference detection pair is changed to be adjacent to the phase difference pixel 61FAw constituting the second-type phase difference detection pair in the down direction YD, and the normal pixel 61G is disposed at a position at which the original phase difference pixel 61FBw is disposed.

In the imaging element 5 illustrated in FIG. 9, the openings of the light shielding film LS of the phase difference pixel 61FAg and the phase difference pixel 61FAw have a configuration in which, for example, the upper half of the opening of the light shielding film LS of the normal pixel 61G is closed. The openings of the light shielding film LS of the phase difference pixel 61FBg and the phase difference pixel 61FBw have a configuration in which, for example, the lower half of the opening of the light shielding film LS of the normal pixel 61G is closed.

As described above, the imaging element 5 illustrated in FIG. 9 has a configuration in which the first-type phase difference detection pair is arranged in the column direction Y in a portion of the pixel group including the plurality of pixels 61 arranged in the column direction Y, and the second-type phase difference detection pair is arranged in the column direction Y in a portion of another pixel group not including the first-type phase difference detection pair.

The system control unit 11 detects a third phase difference in the column direction Y by performing correlation calculation between a pixel signal group output from the phase difference pixel 61FAg included in the same pixel group and a pixel signal group output from the phase difference pixel 61FBg. In addition, the system control unit 11 detects a fourth phase difference in the column direction Y by performing correlation calculation between a pixel signal group output from the phase difference pixel 61FAw included in the same pixel group and a pixel signal group output from the phase difference pixel 61FBw. The system control unit 11 performs the focus detection process of deriving the focus lens position required for focusing on the target subject based on at least one of the third phase difference or the fourth phase difference.

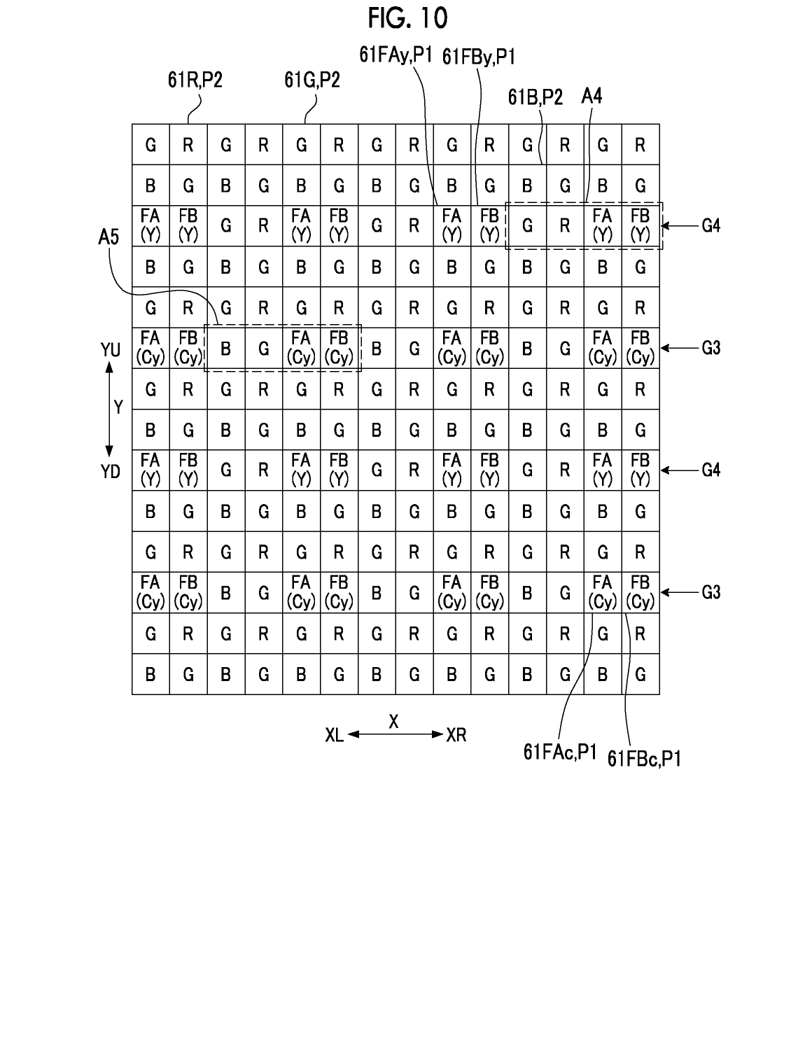

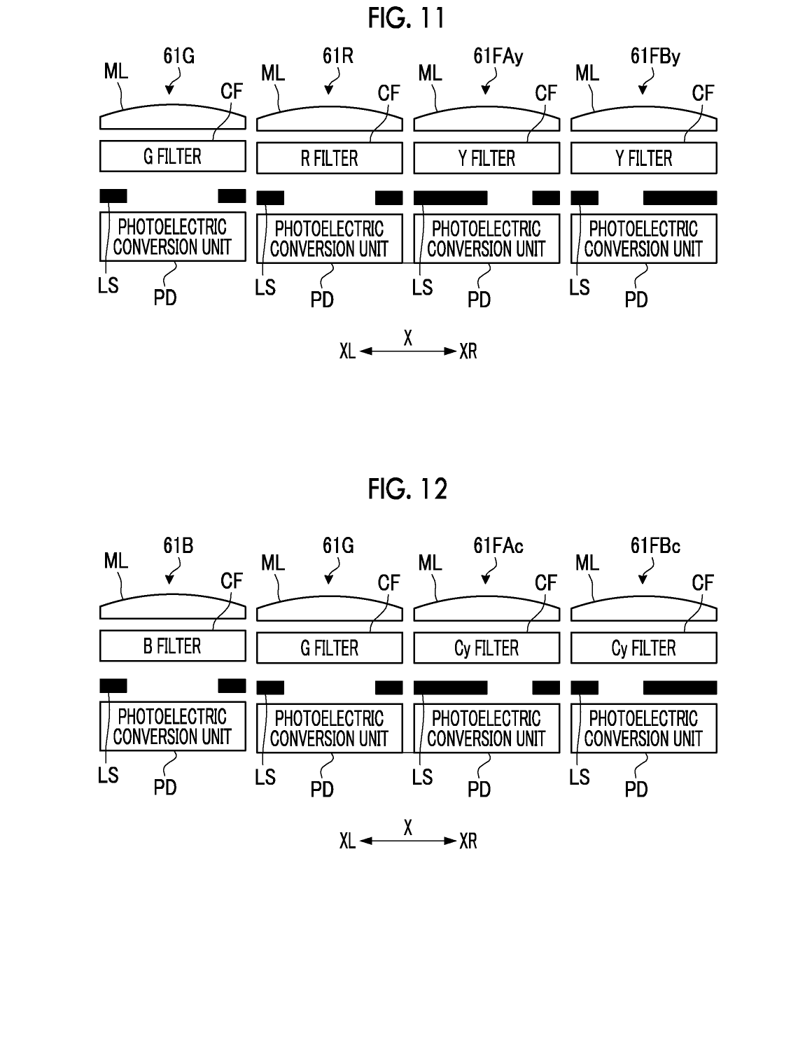

FIG. 10 is a diagram illustrating a third modification example of the imaging element 5, and is a diagram corresponding to FIG. 3. FIG. 11 is a schematic diagram illustrating an example of a cross section of a range A4 illustrated in FIG. 10. FIG. 12 is a schematic diagram illustrating an example of a cross section of a range A5 illustrated in FIG. 10.

In the imaging element 5 illustrated in FIG. 10, the phase difference pixel 61FAg constituting the first-type phase difference detection pair is changed to a phase difference pixel 61FAc (block to which "FA(Cy)" is added in the drawing), and the phase difference pixel 61FBg constituting the first-type phase difference detection pair is changed to a phase difference pixel 61FBc (block to which "FB(Cy)" is added in the drawing) with respect to the imaging element 5 illustrated in FIG. 3.

In addition, in the imaging element 5 illustrated in FIG. 10, the phase difference pixel 61FAw constituting the second-type phase difference detection pair is changed to a phase difference pixel 61FAy (block to which "FA(Y)" is added in the drawing) with respect to the imaging element 5 illustrated in FIG. 3, and the arrangement position thereof is changed from the BG pixel group to the GR pixel group.

In addition, in the imaging element 5 illustrated in FIG. 10, the phase difference pixel 61FBw constituting the second-type phase difference detection pair is changed to a phase difference pixel 61FBy (block to which "FB(Y)" is added in the drawing) with respect to the imaging element 5 illustrated in FIG. 3, and the arrangement position thereof is changed from the BG pixel group to the GR pixel group.

The phase difference pixel 61FAc and the phase difference pixel 61FBc constituting the first-type phase difference detection pair each correspond to two or more of the plurality of wavelength bands (R light, G light, and B light) (specifically, the G light and the B light). The phase difference pixel 61FAc and the phase difference pixel 61FBc receive at least a portion of the G light and at least a portion of the B light, respectively, and output a pixel signal corresponding to the amount of the received light. Since the phase difference pixel 61FAc and the phase difference pixel 61FBc can receive light having more wavelengths than the phase difference pixel 61FAg and the phase difference pixel 61FBg in the imaging element 5 illustrated in FIG. 3, the sensitivity can be increased.

The phase difference pixel 61FAy and the phase difference pixel 61FBy constituting the second-type phase difference detection pair each correspond to two or more of the plurality of wavelength bands (R light, G light, and B light) (specifically, the R light and the G light). The phase difference pixel 61FAy and the phase difference pixel 61FBy receive at least a portion of the R light and at least a portion of the G light, respectively, and output a pixel signal corresponding to the amount of the received light. Since the phase difference pixel 61FAy and the phase difference pixel 61FBy can receive light having more wavelengths than the phase difference pixel 61FAg and the phase difference pixel 61FBg in the imaging element 5 illustrated in FIG. 3, the sensitivity can be increased.

In the imaging element 5 illustrated in FIG. 10, in a portion of the BG pixel group in the plurality of pixel groups provided on the imaging surface 60, the phase difference pixel 61FAc is disposed at a portion of an arrangement position of the normal pixel 61B based on the Bayer pattern, and the phase difference pixel 61FBc is disposed at a portion of an arrangement position of the normal pixel 61G based on the Bayer pattern. The phase difference pixel 61FAc and the phase difference pixel 61FBc are adjacent to each other. A plurality of first-type phase difference detection pairs each consisting of the phase difference pixel 61FAc and the adjacent phase difference pixel 61FBc are arranged in the row direction X with a gap in the portion of the BG pixel group. A plurality of pixel groups G3 each including the first-type phase difference detection pair are arranged in the column direction Y on the imaging surface 60 in a discrete manner.

In addition, in a portion of the GR pixel group in the plurality of pixel groups provided on the imaging surface 60, the phase difference pixel 61FAy is disposed at a portion of an arrangement position of the normal pixel 61G based on the Bayer pattern, and the phase difference pixel 61FBy is disposed at a portion of an arrangement position of the normal pixel 61R based on the Bayer pattern. The phase difference pixel 61FAy and the phase difference pixel 61FBy are adjacent to each other. A plurality of second-type phase difference detection pairs each consisting of the phase difference pixel 61FAy and the adjacent phase difference pixel 61FBy are arranged in the row direction X with a gap in the portion of the GR pixel group. A plurality of pixel groups G4 each including the second-type phase difference detection pair are arranged in the column direction Y on the imaging surface 60 in a discrete manner. As illustrated in FIG. 10, the pixel group G3 and the pixel group G4 are alternately arranged and disposed in the column direction Y.

As illustrated in FIG. 11, a color filter CF (referred to as a Y filter in the drawing) that can transmit at least a portion of the G light and at least a portion of the R light is provided between the microlens ML and the light shielding film LS for each of the phase difference pixel 61FAy and the phase difference pixel 61FBy.

As illustrated in FIG. 12, a color filter CF (referred to as a Cy filter in the drawing) that can transmit at least a portion of the G light and at least a portion of the B light is provided between the microlens ML and the light shielding film LS for each of the phase difference pixel 61FAc and the phase difference pixel 61FBc.

In the digital camera 100 including the imaging element 5 having the above configuration, the system control unit 11 performs the focus detection process based on the pixel value of the phase difference pixel P1.

Specifically, the system control unit 11 detects a fifth phase difference in the row direction X by performing correlation calculation between a pixel signal group output from the phase difference pixel 61FAc included in the same pixel group G3 and a pixel signal group output from the phase difference pixel 61FBc. In addition, the system control unit 11 detects a sixth phase difference in the row direction X by performing correlation calculation between a pixel signal group output from the phase difference pixel 61FAy included in the same pixel group G4 and a pixel signal group output from the phase difference pixel 61FBy. The system control unit 11 performs the focus detection process of deriving the focus lens position required for focusing on the target subject based on at least one of the fifth phase difference or the sixth phase difference.

In the imaging element 5 illustrated in FIG. 10, the sensitivity of each of the first-type phase difference detection pair and the second-type phase difference detection pair can be increased. Therefore, it is possible to increase the detection accuracy of the phase difference. On the other hand, since the first-type phase difference detection pair and the second-type phase difference detection pair can receive light having a plurality of wavelength bands, there is the subject that is not good at detecting a phase difference.

For example, in a case of the subject having the above BG stripe pattern, the phase difference can be detected with high accuracy by using the pixel value of the second-type phase difference detection pair as compared with a case of using the pixel value of the first-type phase difference detection pair. In addition, in a case of the subject having the above RG stripe pattern, the phase difference can be detected with high accuracy by using the pixel value of the first-type phase difference detection pair as compared with a case of using the pixel value of the second-type phase difference detection pair.

Such an effect of improving the phase difference detection accuracy can be similarly obtained, for example, in a configuration in which the positions of the phase difference pixel 61FAy and the phase difference pixel 61FAc are reversed and the positions of the phase difference pixel 61FBy and the phase difference pixel 61FBc are reversed in FIG. 10. However, with the configuration illustrated in FIG. 10, there is an advantage in terms of color mixing.

For example, in the imaging element 5 illustrated in FIG. 10, a portion of the B light and the G light that have passed through the color filter of the phase difference pixel 61FAc and that have advanced in the column direction Y may be incident on the photoelectric conversion unit PD of the normal pixel 61G on both sides of the phase difference pixel 61FAc in the column direction Y, and thus blue color may be mixed in the pixel signal of the normal pixel 61G. However, the normal pixel 61B is disposed adjacent to the normal pixel 61G in the column direction Y, and a portion of the B light that has passed through the color filter CF of the normal pixel 61B may be incident on the photoelectric conversion unit PD of the normal pixel 61G, and thus blue color may be mixed.

In a case where the phase difference pixel 61FAy is provided at the position of the phase difference pixel 61FAc, a portion of the R light that has passed through the color filter CF of the phase difference pixel 61FAy is incident on the photoelectric conversion unit PD of the normal pixel 61G. Therefore, in the normal pixel 61G, blue color and red color may be mixed. As described above, with the configuration illustrated in FIG. 10, since the color mixing that may occur in the normal pixel 61G adjacent to the phase difference pixel 61FAc in the column direction Y can be limited to only one color, it is possible to improve the captured image quality.

In addition, in the imaging element 5 illustrated in FIG. 10, a portion of the B light and the G light that have passed through the color filter of the phase difference pixel 61FAc and that have advanced in the row direction X may be incident on the photoelectric conversion unit PD of the normal pixel 61G adjacent to the phase difference pixel 61FAc in the column direction Y, and thus blue color may be mixed in the pixel signal of the normal pixel 61G. However, the normal pixel 61B is disposed adjacent to the normal pixel 61G in the column direction Y, and a portion of the B light that has passed through the color filter CF of the normal pixel 61B may be incident on the photoelectric conversion unit PD of the normal pixel 61G, and thus blue color may be mixed.

In a case where the phase difference pixel 61FAy is provided at the position of the phase difference pixel 61FAc, a portion of the R light that has passed through the color filter CF of the phase difference pixel 61FAy is incident on the photoelectric conversion unit PD of the normal pixel 61G. Therefore, in the normal pixel 61G, blue color and red color may be mixed. As described above, with the configuration illustrated in FIG. 10, since the color mixing that may occur in the normal pixel 61G adjacent to the phase difference pixel 61FAc in the row direction X can be limited to only one color, it is possible to improve the captured image quality.

This effect of suppressing color mixing can be similarly obtained in the normal pixel 61G on both sides of the phase difference pixel 61FBy in the column direction Y and the normal pixel 61G adjacent to the phase difference pixel 61FBy in the row direction X. Further, such an effect can be similarly obtained in the normal pixel 61R adjacent to the phase difference pixel 61FAy in the row direction X. Further, such an effect can be similarly obtained in the normal pixel 61B adjacent to the phase difference pixel 61FBc in the row direction X.

The system control unit 11 may perform control of making the exposure times different between the pixel group G3 including the first-type phase difference detection pair and the pixel group G4 including the second-type phase difference detection pair in the imaging element 5 illustrated in FIG. 10. With this control, the detection accuracy of the phase difference can be further increased.

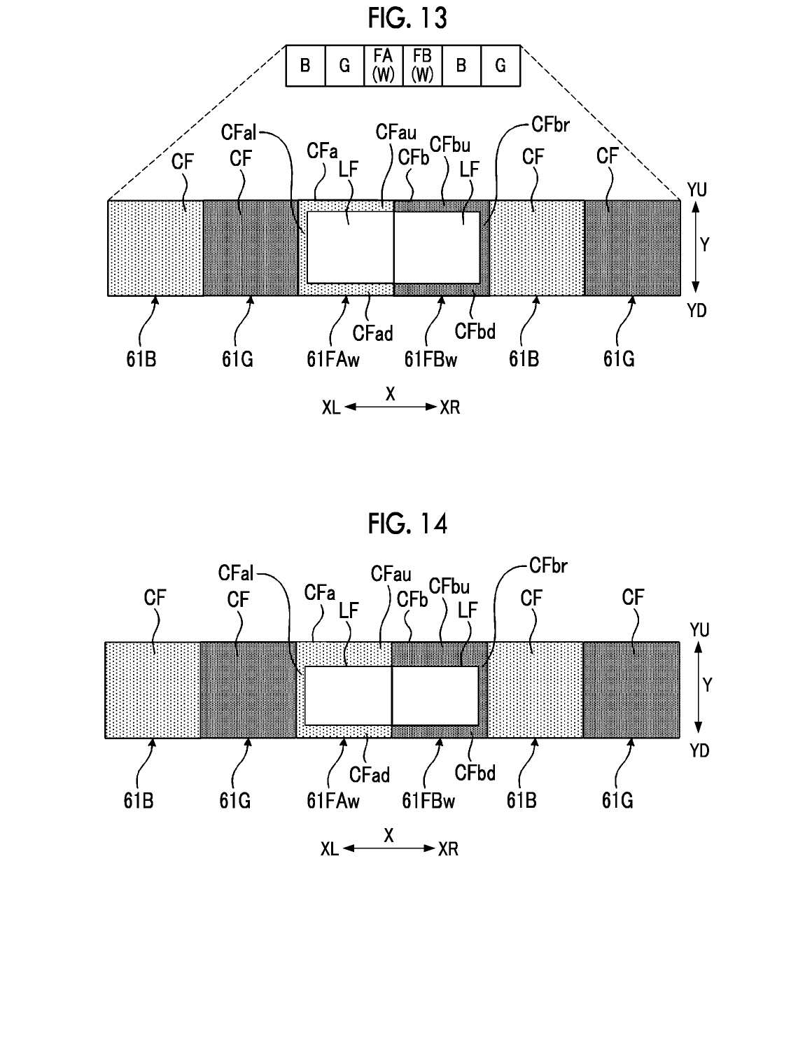

FIG. 13 is a schematic diagram illustrating a fourth modification example of the imaging element 5. Although the pixel arrangement of the imaging element 5 of the fourth modification example is the same as that illustrated in FIG. 3, the internal structures of the phase difference pixel 61FAw and the phase difference pixel 61FBw are different. FIG. 13 illustrates a state in which a layer between the light shielding film LS and the microlens ML is viewed from the microlens ML side in six pixels 61 in a range A6 illustrated in FIG. 3 in the imaging element 5 of the fourth modification example.

The arrangement position of the phase difference pixel 61FAw illustrated in FIG. 13 is the arrangement position of the normal pixel 61B based on the Bayer pattern. A color filter CFa that transmits at least a portion of the B light, which is a wavelength band corresponding to the normal pixel 61B, is provided at a peripheral edge portion of the phase difference pixel 61FAw disposed at a position at which the normal pixel 61B is to be disposed based on the Bayer pattern.

The color filter CFa is provided in the same layer as the color filter CF. The color filter CFa is provided in a substantially C-shape around the brightness filter LF. The color filter CFa comprises a first portion CFau provided along an end edge of the brightness filter LF in the up direction YU, a second portion CFad provided along an end edge of the brightness filter LF in the down direction YD, and a third portion CFal provided along an end edge of the brightness filter LF in the left direction XL to connect end edges of the first portion CFau and the second portion CFad in the left direction XL.

The arrangement position of the phase difference pixel 61FBw illustrated in FIG. 13 is the arrangement position of the normal pixel 61G based on the Bayer pattern. A color filter CFb that transmits at least a portion of the G light, which is a wavelength band corresponding to the normal pixel 61G, is provided at a peripheral edge portion of the phase difference pixel 61FBw disposed at a position at which the normal pixel 61G is to be disposed based on the Bayer pattern.

The color filter CFb is provided in the same layer as the color filter CF. The color filter CFb is provided in a substantially inverted C-shape around the brightness filter LF. The color filter CFb comprises a first portion CFbu provided along an end edge of the brightness filter LF in the up direction YU, a second portion CFbd provided along an end edge of the brightness filter LF in the down direction YD, and a third portion CFbr provided along an end edge of the brightness filter LF in the right direction XR to connect end edges of the first portion CFbu and the second portion CFbd in the right direction XR.

With the configuration of the phase difference pixel 61FAw and the phase difference pixel 61FBw illustrated in FIG. 13, the R light and the G light among the R light, the G light, and the B light that have passed through the brightness filter LF of the phase difference pixel 61FAw can be attenuated by the color filter CFa. As a result, most of the light incident on the photoelectric conversion unit PD of the normal pixel P2 adjacent to the phase difference pixel 61FAw can be made blue, and thus the occurrence of color mixing of a plurality of colors in the normal pixel P2 can be prevented.

Further, the R light and the B light among the R light, the G light, and the B light that have passed through the brightness filter LF of the phase difference pixel 61FBw can be attenuated by the color filter CFb. As a result, most of the light incident on the photoelectric conversion unit PD of the normal pixel P2 adjacent to the phase difference pixel 61FBw can be made green, and thus the occurrence of color mixing of a plurality of colors in the normal pixel P2 can be prevented.

The phase difference pixel 61FAw may have a configuration in which a width of the first portion CFau of the color filter CFa in the column direction Y, a width of the second portion CFad of the color filter CFa in the column direction Y, and a width of the third portion CFal of the color filter CFa in the row direction X are different depending on the arrangement position of the phase difference pixel 61FAw on the imaging surface 60.

In addition, the phase difference pixel 61FBw may have a configuration in which a width of the first portion CFbu of the color filter CFb in the column direction Y, a width of the second portion CFbd of the color filter CFb in the column direction Y, and a width of the third portion CFbr of the color filter CFb in the row direction X are different depending on the arrangement position of the phase difference pixel 61FBw on the imaging surface 60.

For example, as illustrated in FIG. 14, for the phase difference pixel 61FAw and the phase difference pixel 61FBw at an end portion of the imaging surface 60 in the up direction YU, a width of the first portion CFau in the column direction Y and a width of the first portion CFbu in the column direction Y are made larger than those of the phase difference pixel 61FAw and the phase difference pixel 61FBw at a central portion of the imaging surface 60 in the column direction Y, respectively.

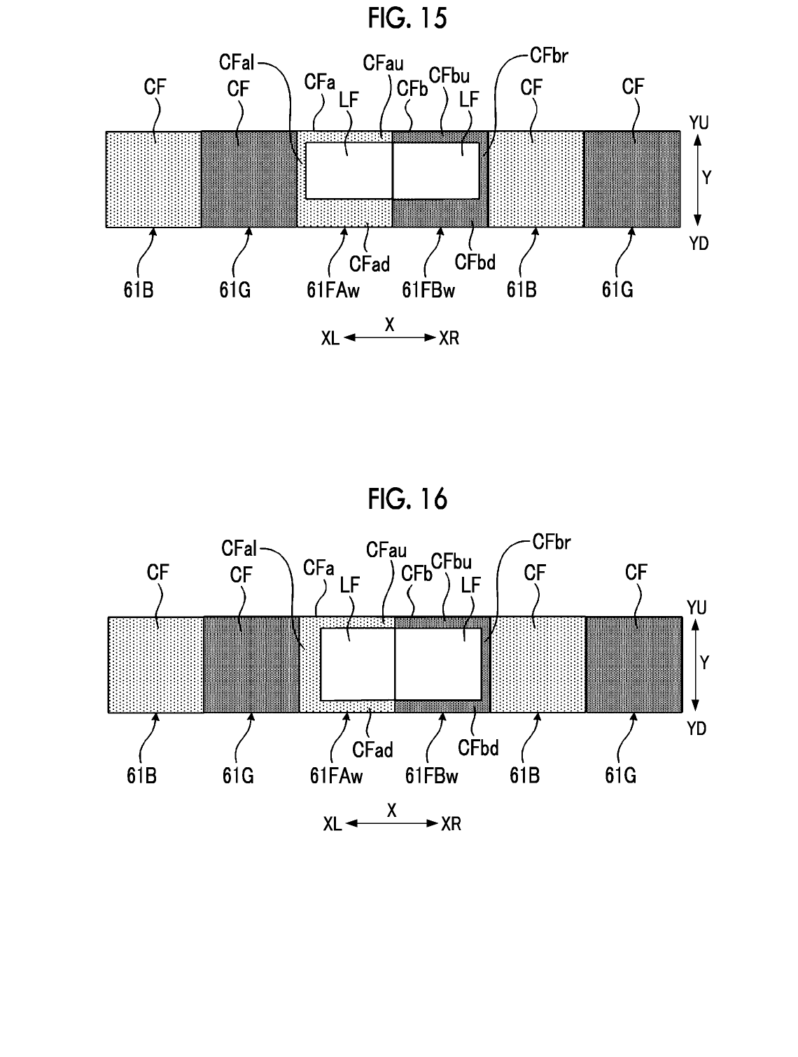

In addition, as illustrated in FIG. 15, for the phase difference pixel 61FAw and the phase difference pixel 61FBw at an end portion of the imaging surface 60 in the down direction YD, a width of the second portion CFad in the column direction Y and a width of the second portion CFbd in the column direction Y are made larger than those of the phase difference pixel 61FAw and the phase difference pixel 61FBw at a central portion of the imaging surface 60 in the column direction Y, respectively.

In addition, as illustrated in FIG. 16, for the phase difference pixel 61FAw and the phase difference pixel 61FBw at an end portion of the imaging surface 60 in the left direction XL, a width of the third portion CFal in the row direction X is made larger than that of the phase difference pixel 61FAw at a central portion of the imaging surface 60 in the row direction X.

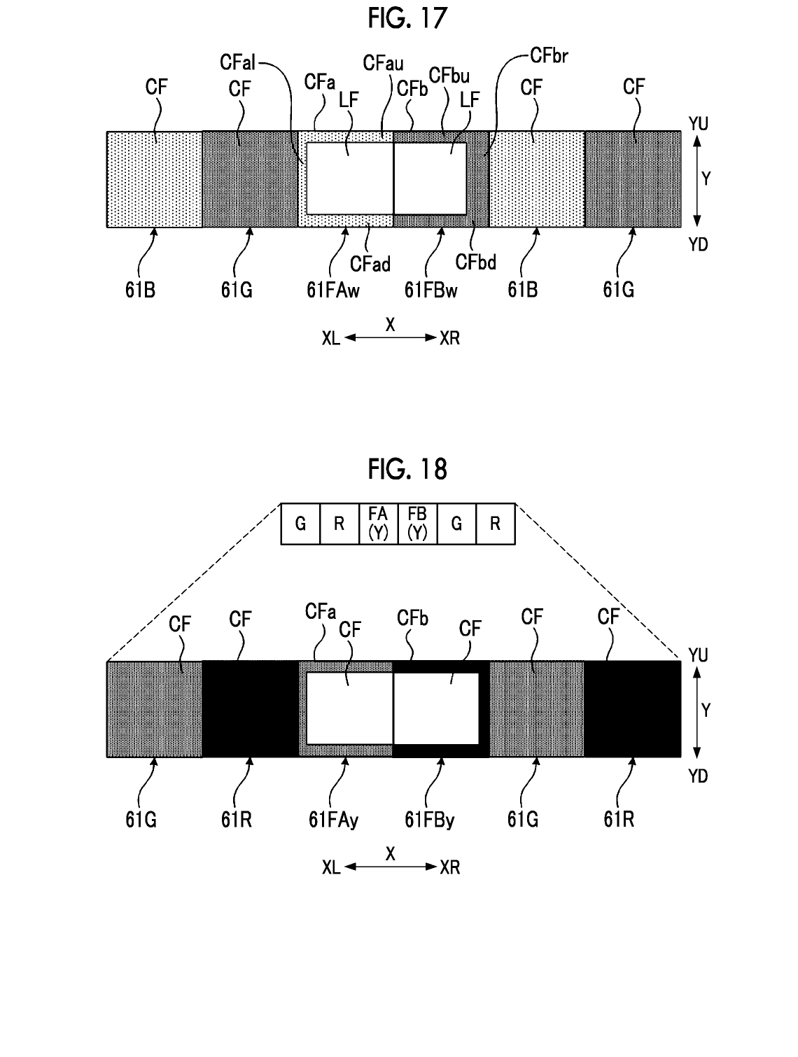

In addition, as illustrated in FIG. 17, for the phase difference pixel 61FAw and the phase difference pixel 61FBw at an end portion of the imaging surface 60 in the right direction XR, a width of the third portion CFbr in the row direction X is made larger than that of the phase difference pixel 61FBw at a central portion of the imaging surface 60 in the row direction X.

As described above, by changing the widths of the color filter CFa and the color filter CFb according to the arrangement positions of the phase difference pixel 61FAw and the phase difference pixel 61FBw, the occurrence of color mixing of a plurality of colors in the pixels 61 adjacent to these can be suppressed even in a peripheral portion of the imaging surface 60 where the incidence angle of light is severe.

The configurations of the color filter CFa and the color filter CFb illustrated in FIGS. 13 to 17 can also be applied to the imaging element 5 having the configuration illustrated in FIG. 10. For example, as illustrated in FIG. 18, a color filter CFa that transmits at least a portion of the G light is added to the phase difference pixel 61FAy in a form of surrounding the color filter CF included in the phase difference pixel 61FAy. Therefore, the R light that has passed through the color filter CF of the phase difference pixel 61FAy can be prevented from being incident on the photoelectric conversion unit PD of the normal pixel P2 adjacent to the phase difference pixel 61FAy.

Further, a color filter CFb that transmits at least a portion of the R light is added to the phase difference pixel 61FBy in a form of surrounding the color filter CF included in the phase difference pixel 61FBy. Therefore, the G light that has passed through the color filter CF of the phase difference pixel 61FBy can be prevented from being incident on the photoelectric conversion unit PD of the normal pixel P2 adjacent to the phase difference pixel 61FBy.

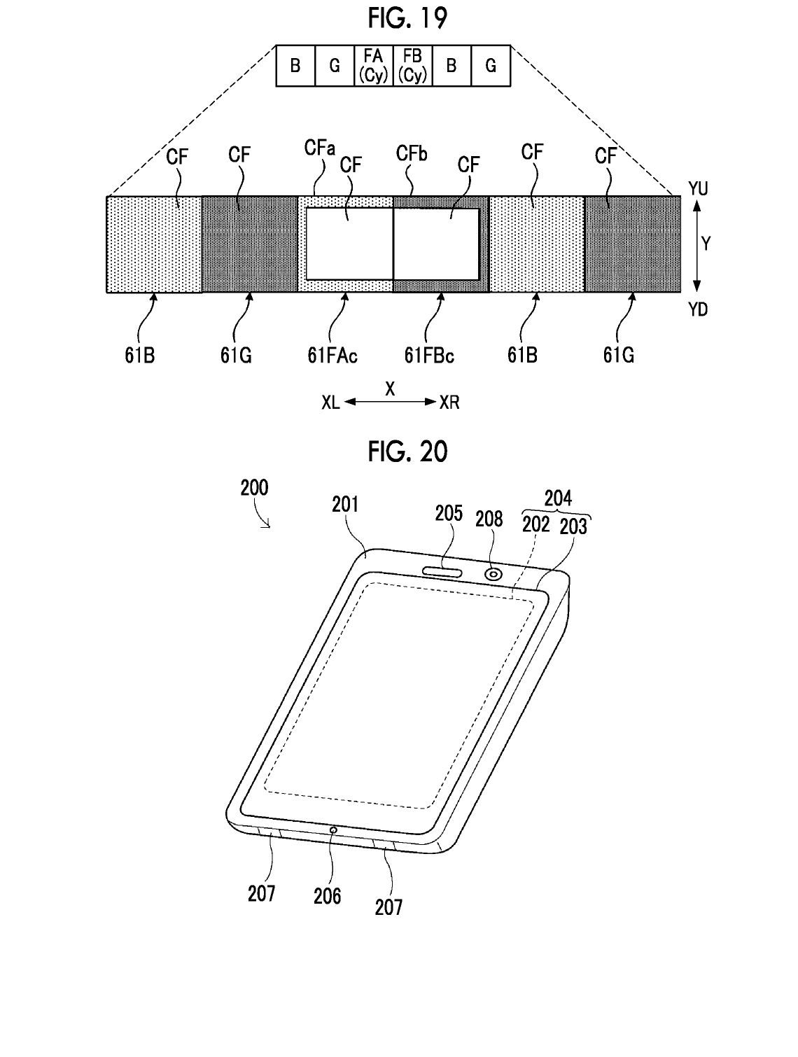

Further, as illustrated in FIG. 19, a color filter CFa that transmits at least a portion of the B light is added to the phase difference pixel 61FAc in a form of surrounding the color filter CF included in the phase difference pixel 61FAc. Therefore, the G light that has passed through the color filter CF of the phase difference pixel 61FAc can be prevented from being incident on the photoelectric conversion unit PD of the normal pixel P2 adjacent to the phase difference pixel 61FAc.

Further, a color filter CFb that transmits at least a portion of the G light is added to the phase difference pixel 61FBc in a form of surrounding the color filter CF included in the phase difference pixel 61FBc. Therefore, the B light that has passed through the color filter CF of the phase difference pixel 61FBc can be prevented from being incident on the photoelectric conversion unit PD of the normal pixel P2 adjacent to the phase difference pixel 61FBc.

Hereinafter, a configuration of a smartphone that is another embodiment of the imaging device according to the technology of the present disclosure will be described.

FIG. 20 is a diagram illustrating an appearance of a smartphone 200. The smartphone 200 illustrated in FIG. 20 comprises a flat plate-shaped housing 201, and a display input unit 204 in which a display panel 202 as a display unit and an operation panel 203 as an input unit are integrated on one surface of the housing 201.

Further, the housing 201 comprises a speaker 205, a microphone 206, an operation unit 207, and a camera unit 208. The configuration of the housing 201 is not limited thereto, and for example, a configuration can be adopted in which the display unit and the input unit are separately provided, or a configuration having a folding structure or a slide mechanism.

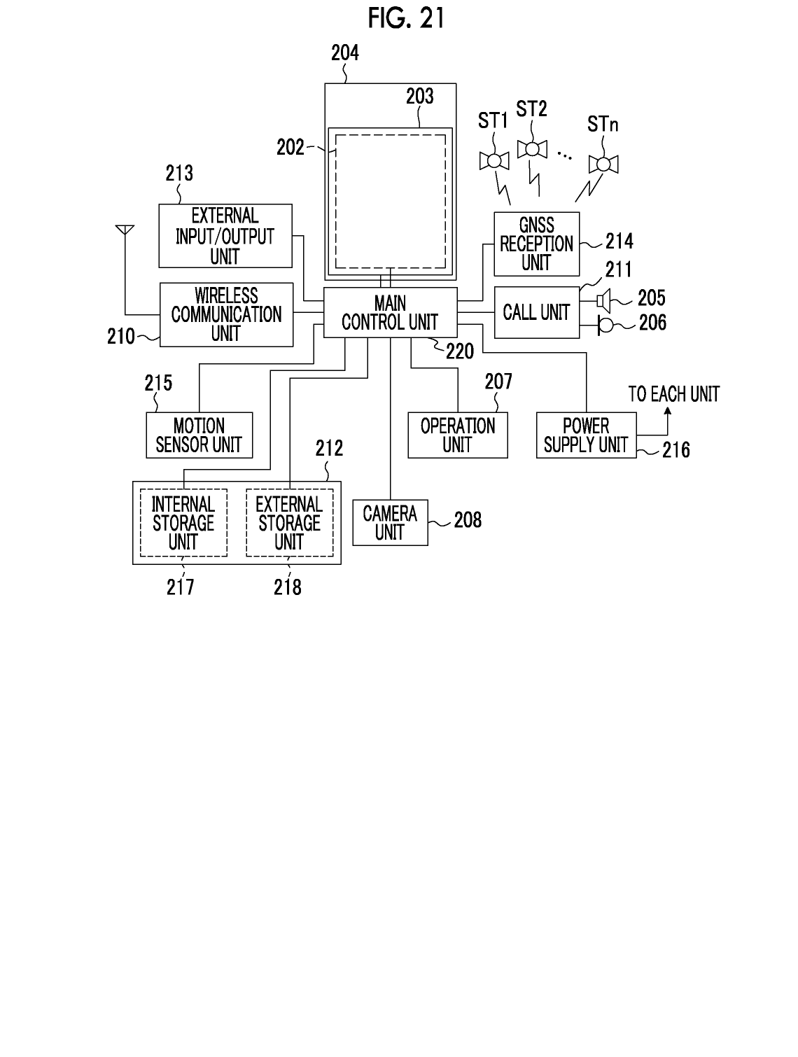

FIG. 21 is a block diagram illustrating a configuration of the smartphone 200 illustrated in FIG. 20.

As illustrated in FIG. 21, the smartphone comprises, as main constituents, a wireless communication unit 210, the display input unit 204, a call unit 211, the operation unit 207, the camera unit 208, a storage unit 212, an external input/output unit 213, a global navigation satellite system (GNSS) reception unit 214, a motion sensor unit 215, a power supply unit 216, and a main control unit 220.

The smartphone 200 has, as a main function, a wireless communication function for performing mobile wireless communication via a base station device BS (not illustrated) and a mobile communication network NW (not illustrated).

The wireless communication unit 210 performs wireless communication with the base station device BS accommodated in the mobile communication network NW according to the command of the main control unit 220. Using the wireless communication, the transmission and reception of various file data, such as voice data and image data, e-mail data, and reception of web data, or streaming data, is performed.

The display input unit 204 is a so-called touch panel that displays images (still images and moving images) or text information under the control of the main control unit 220 to visually transmit the information to the user, and detects the user's operation to the displayed information, and comprises the display panel 202 and the operation panel 203.

The display panel 202 uses a liquid crystal display (LCD), an organic electro-luminescence display (OELD), and the like as a display device.

The operation panel 203 is a device which is placed to be capable of visually recognizing the image displayed on the display surface of the display panel 202, and is operated by the user's finger or a stylus to detect one or a plurality of coordinates. In a case where the device is operated by the user's finger or the stylus, detection signals generated due to the operation are output to the main control unit 220. Then, the main control unit 220 detects an operation position (coordinates) on the display panel 202 based on the received detection signals.

As illustrated in FIG. 21, although the display panel 202 and the operation panel 203 of the smartphone 200 illustrated as an embodiment of the imaging device according to the present invention are integrated to constitute the display input unit 204, the operation panel 203 is disposed to completely cover the display panel 202.

In a case where such an arrangement is adopted, the operation panel 203 may have a function of detecting the user's operation even in a region outside the display panel 202. Stated another way, the operation panel 203 may comprise a detection region for the overlapping portion (hereinafter, referred to as a display region) that overlaps the display panel 202, and a detection region for the outer edge portion (hereinafter, referred to as a non-display region) that does not overlap the display panel 202 other than the overlapping portion.

The size of the display region and the size of the display panel 202 may completely match, but it is not always necessary to match the size of the display region and the size of the display panel 202. The operation panel 203 may comprise two sensitive regions in the outer edge portion and the inner portion other than the outer edge portion. Further, the width of the outer edge portion is designed as appropriate depending on the size of the housing 201 and the like.

Furthermore, examples of the position detection method adopted in the operation panel 203 include a matrix switch method, a resistive film method, a surface acoustic wave method, an infrared method, an electromagnetic induction method, and a capacitive method, and any method can be adopted.

The call unit 211 comprises the speaker 205 or the microphone 206, and converts the user's voice that is input through the microphone 206 into voice data which can be processed by the main control unit 220 to output the converted voice data to the main control unit 220, or decodes the voice data received by the wireless communication unit 210 or the external input/output unit 213 to output the decoded voice data through the speaker 205.

For example, as illustrated in FIG. 20, the speaker 205 may be mounted on the same surface as the surface on which the display input unit 204 is provided, and the microphone 206 may be mounted on a side surface of the housing 201.

The operation unit 207 is a hardware key using a key switch or the like, and receives the command of the user. For example, as illustrated in FIG. 20, the operation unit 207 is a push button type switch which is mounted on a side surface of the housing 201 of the smartphone 200, and is turned on by being pressed with the finger and is turned off by a restoring force such as a spring in a case where the finger is released.

The storage unit 212 stores a control program and control data of the main control unit 220, application software, address data associated with the name or telephone number of a communication partner, data of transmitted and received e-mails, web data downloaded from web browsing, and downloaded content data, and temporarily stores streaming data or the like. The storage unit 212 is configured by an internal storage unit 217 built in the smartphone and an external storage unit 218 having an attachable and detachable external memory slot.

Each of the internal storage unit 217 and the external storage unit 218 constituting the storage unit 212 is implemented using a storage medium such as a memory (for example, a MicroSD (registered trademark) memory) of a flash memory type, a hard disk type, a multimedia card micro type, or a card type, a random-access memory (RAM), or a read-only memory (ROM).

The external input/output unit 213 serves as an interface with all external devices connected to the smartphone 200 and is directly or indirectly connected to other external devices by communication or the like (for example, a universal serial bus (USB), IEEE1394, Bluetooth (registered trademark), radio frequency identification (RFID), infrared communication (Infrared Data Association (IrDA) (registered trademark)), Ultra Wideband (UWB) (registered trademark), or ZigBee (registered trademark)) or through a network (for example, Ethernet (registered trademark) or a wireless local area network (LAN)).

For example, the external devices connected to the smartphone 200 include a wired/wireless headset, a wired/wireless external charger, a wired/wireless data port, a memory card and a subscriber identity module (SIM)/user identity module (UIM) card connected via a card socket, an external audio and video device connected via an audio and video input/output (I/O) terminal, an external audio and video device connected in a wireless manner, a smartphone connected in a wired/wireless manner, a personal computer connected in a wired/wireless manner, and an earphone.

The external input/output unit 213 can transmit data transmitted from such external devices to the components inside the smartphone 200, or transmit data inside the smartphone 200 to the external devices.

The GNSS reception unit 214 receives GNSS signals transmitted from GNSS satellites ST1 to STn, executes positioning computation processing based on the received plurality of GNSS signals, and detects a position consisting of a latitude, a longitude, and an altitude of the smartphone 200 according to commands from the main control unit 220. In a case where positional information can be acquired from the wireless communication unit 210 or from the external input/output unit 213 (for example, a wireless LAN), the GNSS reception unit 214 can detect the position using the positional information.

The motion sensor unit 215 comprises, for example, a three-axis acceleration sensor, and detects physical movement of the smartphone 200 according to the command of the main control unit 220. By detecting the physical movement of the smartphone 200, the movement direction or the acceleration of the smartphone 200 is detected. Such a detection result is output to the main control unit 220.

The power supply unit 216 supplies the power stored in a battery (not illustrated) to each unit of the smartphone 200 according to the command of the main control unit 220.

The main control unit 220 comprises a microprocessor, operates according to the control program and the control data stored in the storage unit 212, and controls the units of the smartphone 200 in an integrated manner. The microprocessor of the main control unit 220 has the same function as the system control unit 11. Further, the main control unit 220 has a mobile communication control function of controlling the units of the communication system, and an application processing function in order to perform voice communication or data communication through the wireless communication unit 210.

The application processing function is realized by the main control unit 220 which operates according to the application software stored in the storage unit 212. Examples of the application processing function include an infrared ray communication function of controlling the external input/output unit 213 to perform data communication with another device, an e-mail function of performing transmission and reception of e-mail, or a web browsing function of browsing a web page.

The main control unit 220 has an image processing function of displaying an image on the display input unit 204 based on the image data (data of still image or moving images) such as received data or downloaded streaming data.

The image processing function is a function in which the main control unit 220 decodes the image data, performs image processing on this decoding result, and displays the image on the display input unit 204.

Furthermore, the main control unit 220 executes display control with respect to the display panel 202 and operation detection control of detecting the user's operation through the operation unit 207 and the operation panel 203.

By executing the display control, the main control unit 220 displays a software key such as an icon or a scroll bar for starting the application software, or displays a window for creating an e-mail.

In addition, the scroll bar is a software key for receiving a command to move a displayed portion of the image for a large image that cannot fit in the display region of the display panel 202.

By executing the operation detection control, the main control unit 220 detects the user's operation through the operation unit 207, receives the operation with respect to the icon and the input of the character string for the input field of the window through the operation panel 203, or receives a scroll request of the displayed image through the scroll bar.

By executing the operation detection control, the main control unit 220 has a touch panel control function of determining whether the operation position on the operation panel 203 is the overlapping portion (display region) that overlaps the display panel 202 or the outer edge portion (non-display region) that does not overlap the display panel 202 other than the overlapping portion, and controlling the sensitive region of the operation panel 203 and the display position of the software key.

The main control unit 220 can detect a gesture operation on the operation panel 203 and execute a preset function according to the detected gesture operation.

The gesture operation is not a usual simple touch operation, but is an operation of drawing a path with fingers, designating a plurality of positions at the same time, or combining these operations to draw a locus for at least one from a plurality of positions.

The camera unit 208 includes the lens device 40, the imaging element 5, and the digital signal processing unit 17 illustrated in FIG. 1.

The captured image data generated by the camera unit 208 can be stored in the storage unit 212 or can be output through the external input/output unit 213 or the wireless communication unit 210.

In the smartphone 200 illustrated in FIG. 21, the camera unit 208 is mounted on the same surface as the display input unit 204, but a mount position of the camera unit 208 is not limited thereto, and the camera unit 208 may be mounted on a rear surface of the display input unit 204.

In addition, the camera unit 208 can be used for various functions of the smartphone 200. For example, the image acquired by the camera unit 208 can be displayed on the display panel 202, or the image from the camera unit 208 can be used as one of operation inputs of the operation panel 203.

In a case where the GNSS reception unit 214 detects the position, the position can be detected by referring to the image from the camera unit 208. Furthermore, by referring to the image from the camera unit 208, it is possible to determine the optical axis direction of the camera unit 208 of the smartphone 200 or to determine the current use environment without using the three-axis acceleration sensor or by using the three-axis acceleration sensor in combination. It goes without saying that the image from the camera unit 208 can be used in the application software.

In addition, image data of a still image or of a moving image to which the positional information acquired by the GNSS reception unit 214, voice information (may be text information acquired by performing voice to text conversion via the main control unit or the like) acquired by the microphone 206, posture information acquired by the motion sensor unit 215, or the like is added can be stored in the storage unit 212 or be output through the external input/output unit 213 or through the wireless communication unit 210.

Various embodiments have been described above, but it goes without saying that the present invention is not limited to such examples. It will be apparent to those skilled in the art that various modifications and alterations can be conceived within the scope set forth in the claims, and such modifications are understood to fall within the technical scope of the present invention. Further, the components in the embodiments described above may be arbitrarily combined without departing from the gist of the invention.

This application is based on Japanese Patent Application No. 2023-169880, filed on September 29, 2023, the contents of which are incorporated herein by reference.

### EXPLANATION OF REFERENCES

1: imaging lens

A1, A2, A3, A4, A5, A6: range

4: lens control unit

5: imaging element

8: lens drive unit

9: stop drive unit

11: system control unit

14, 207: operation unit

15: memory control unit

16: memory

17: digital signal processing unit

20: external memory control unit

21: storage medium

22: display device

22a: display controller

22b: display surface

24: control bus

25: data bus

40: lens device

60: imaging surface

61: pixel

61B, 61G, 61R: normal pixel

61FAg, 61FBg, 61FAw, 61FBw: phase difference pixel

61FAc, 61FBc, 61FAy, 61FBy: phase difference pixel

62: pixel group

63: drive circuit

64: signal processing circuit

100: digital camera

100A: body part

200: smartphone

201: housing

202: display panel

203: operation panel

204: display input unit

205: speaker

206: microphone

208: camera unit

210: wireless communication unit

211: call unit

212: storage unit

213: external input/output unit

214: GNSS reception unit

215: motion sensor unit

216: power supply unit

217: internal storage unit

218: external storage unit

220: main control unit

P: phase difference pixel

P2: normal pixel

G1, G2, G3, G4: pixel group

What is claimed is:

1. An imaging element comprising: a plurality of pixels, wherein the plurality of pixels include first pixels for phase difference detection and second pixels different from the first pixels, the second pixels include a plurality of types of pixels corresponding to a plurality of wavelength bands, the first pixels include a first-type pixel corresponding to at least one of the plurality of wavelength bands and a second-type pixel different from the first-type pixel and corresponding to two or more of the plurality of wavelength bands, the imaging element further comprises an imaging surface on which a plurality of first-type phase-difference detection pairs each comprising a plurality of the first-type pixels aligned in a first direction are arranged in a second direction intersecting the first direction, and a plurality of second-type phase-difference detection pairs each comprising a plurality of the second-type pixels aligned in the first direction are arranged in the second direction, and the first-type phase-difference detection pairs and the second-type phase-difference detection pairs are alternately arranged in the second direction.

2. The imaging element according to claim 1, wherein the first-type pixel corresponds to any of the plurality of wavelength bands, and
the second-type pixel corresponds to all of the plurality of wavelength bands.

3. The imaging element according to claim 2,
wherein the plurality of wavelength bands include a first wavelength band, a second wavelength band, and a third wavelength band.

4. The imaging element according to claim 3, wherein the first wavelength band is a red wavelength band, the second wavelength band is a green wavelength band, the third wavelength band is a blue wavelength band, and the first-type pixel corresponds to the second wavelength band.

5. The imaging element according to claim 1, wherein the first-type pixel corresponds to two or more of the plurality of wavelength bands.

6. The imaging element according to claim 5,
wherein the plurality of wavelength bands include a first wavelength band, a second wavelength band, and a third wavelength band,
the first-type pixel corresponds to the second wavelength band and the third wavelength band, and
the second-type pixel corresponds to the first wavelength band and the second wavelength band.

7. The imaging element according to claim 6, wherein the second pixels are arranged in a predetermined pattern, and the first-type pixel is provided at a portion of arrangement positions of the second pixels corresponding to the second wavelength band based on the pattern and a portion of arrangement positions of the second pixels corresponding to the third wavelength band based on the pattern.

8. The imaging element according to claim 7,
wherein the second-type pixel is provided at a portion of arrangement positions of the second pixels corresponding to the first wavelength band based on the pattern and a portion of arrangement positions of the second pixels corresponding to the second wavelength band based on the pattern.

9. The imaging element according to claim 1, wherein the first pixels are capable of detecting a phase difference in the first direction.

10. An imaging element comprising: a plurality of pixels, wherein the plurality of pixels include first pixels for phase difference detection and second pixels different from the first pixels, the second pixels include a plurality of types of pixels corresponding to a plurality of wavelength bands, the first pixels include a first-type pixel corresponding to at least one of the plurality of wavelength bands and a second-type pixel different from the first-type pixel and corresponding to two or more of the plurality of wavelength bands, the first-type pixel corresponds to any of the plurality of wavelength bands, the number of corresponding wavelength bands within the plurality of wavelength bands of the second-type pixel is greater than the number of corresponding wavelength bands within the plurality of wavelength bands of the first-type pixel, the second pixels are arranged in a predetermined pattern, the first pixels are provided at a portion of arrangement positions of the second pixels based on the pattern, a filter that transmits a corresponding wavelength band of the second pixel corresponding to the arrangement position of the second-type pixel based on the pattern is provided at least at a part of peripheral edge portion of the second-type pixel, and a plurality of the second-type pixels are arranged adjacent to each other, and the filter is not provided at a portion of the peripheral edge portion at which an adjacent one of the second-type pixels is arranged.

11. The imaging element according to claim 10, further comprising: an imaging surface in which a plurality of pixel groups each including a plurality of the pixels arranged in a first direction are arranged in a second direction intersecting the first direction, wherein a width of the filter in the first direction at an end portion of the second-type pixel in the first direction and a width of the filter in the second direction at an end portion of the second-type pixel in the second direction are different depending on a position of the second-type pixel on the imaging surface.

12. An imaging element comprising: a plurality of pixels, wherein the plurality of pixels include first pixels for phase difference detection and second pixels different from the first pixels, the second pixels include a plurality of types of pixels corresponding to a plurality of wavelength bands, the first pixels include a first-type pixel corresponding to at least one of the plurality of wavelength bands and a second-type pixel different from the first-type pixel and corresponding to two or more of the plurality of wavelength bands, the first-type pixel corresponds to two or more of the plurality of wavelength bands, the second pixels are arranged in a predetermined pattern, the first pixels are provided at a portion of arrangement positions of the second pixels based on the pattern,a filter that transmits a corresponding wavelength band of the second pixel corresponding to the arrangement position of the first pixel based on the pattern is provided at least at a part of peripheral edge portion of the first pixel, and a plurality of the second-type pixels are arranged adjacent to each other, and the filter is not provided at a portion of the peripheral edge portion at which an adjacent one of the second-type pixels is arranged.

13. The imaging element according to claim 12, further comprising: an imaging surface in which a plurality of pixel groups each including a plurality of the pixels arranged in a first direction are arranged in a second direction intersecting the first direction, wherein a width of the filter in the first direction at an end portion of the first pixel in the first direction and a width of the filter in the second direction at an end portion of the first pixel in the second direction are different depending on a position of the first pixel on the imaging surface.

14. The imaging element according to claim 1,
wherein the plurality of wavelength bands are within a wavelength band of visible light.

15. An imaging device comprising: the imaging element according to claim 1; and a processor that performs a focus detection process based on a pixel value of the first pixel.

16. The imaging device according to claim 15,
wherein the processor performs control of making exposure times different between the first-type pixel and the second-type pixel.

17. An imaging element comprising: a plurality of pixels, wherein the plurality of pixels include first pixels for phase difference detection and second pixels different from the first pixels, the second pixels include a plurality of types of pixels corresponding to a plurality of wavelength bands, the first pixels include a first-type pixel corresponding to at least one of the plurality of wavelength bands and a second-type pixel different from the first-type pixel and corresponding to two or more of the plurality of wavelength bands, the imaging element further comprises an imaging surface on which a plurality of first-type phase-difference detection pairs each comprising a plurality of the first-type pixels aligned in a first direction are arranged in a second direction intersecting the first direction, and a plurality of second-type phase-difference detection pairs each comprising a plurality of the second-type pixels aligned in the first direction are arranged in the second direction, and the first-type phase-difference detection pairs and the second-type phase-difference detection pairs are alternately arranged in the first direction.

18. An imaging element comprising: a plurality of pixels, wherein the plurality of pixels include first pixels for phase difference detection and second pixels different from the first pixels, the second pixels include a plurality of types of pixels corresponding to a plurality of wavelength bands, the first pixels include a first-type pixel corresponding to at least one of the plurality of wavelength bands and a second-type pixel different from the first-type pixel and corresponding to two or more of the plurality of wavelength bands, the imaging element further comprises an imaging surface on which a plurality of first-type phase-difference detection pairs each comprising a plurality of the first-type pixels aligned in a second direction are arranged in the second direction, and a plurality of second-type phase-difference detection pairs each comprising a plurality of the second-type pixels aligned in the second direction are arranged in the second direction, andthe first-type phase-difference detection pairs and the second-type phase-difference detection pairs are alternately arranged in at least one of the second direction or a first direction intersecting the second direction.
